(19) United States
(12) Patent Application Publication
(10) Pub. No.: US 2026/0343589 A1
(43) Pub. Date: Oct. 29, 2026

(54) PRIORITY HANDLING IN INTER-DISTRIBUTED-UNIT CARRIER AGGREGATION

(71) Applicant: QUALCOMM Incorporated, San Diego, CA (US)

(72) Inventors: Chiranjib SAHA, Lakeside, CA (US); Umesh PHUYAL, San Diego, CA (US)

(21) Appl. No.: 19/189,966

(22) Filed: Apr. 25, 2025

(51) Int. Cl. H04W 72/56

(52) U.S. Cl. CPC H04W 72/56

(57) ABSTRACT

Various aspects of the present disclosure generally relate to wireless communication. In some aspects, a first distributed unit (DU) may transmit, to a second DU, a data scheduling request for scheduling transmission of data from the second DU to a user equipment (UE) via a secondary cell (SCell) for the UE, and an indication of a priority associated with the UE. The DU may receive, from the second DU, a data request associated with a data transmission from the second DU to the UE via the SCell scheduled in accordance with the data scheduling request and the priority associated with the UE. The DU may transmit, to the second DU, a data response including a transport block for the data transmission from the second DU to the UE via the SCell. Numerous other aspects are described.

### FIELD OF THE DISCLOSURE

Aspects of the present disclosure generally relate to wireless communication and specifically relate to techniques, apparatuses, and methods associated with priority handling and medium access control (MAC) control element transfer in inter-distributed-unit carrier aggregation.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

Another telecommunication standard is open radio access network (O-RAN), which is promulgated by the O-RAN Alliance. O-RAN is an initiative aimed at creating more open and interoperable radio access networks. In an O-RAN architecture, radio access network functions may be disaggregated into various components, such as central units (CUs), distributed units (DUs), and radio units (RUs), to allow for more flexible and scalable network deployments.

### BRIEF DESCRIPTION OF THE DRAWINGS

FIG. 1 is a diagram illustrating an example of a wireless communication network.

FIG. 2 is a diagram illustrating an example disaggregated network node architecture.

FIG. 3 is a diagram illustrating an example of a functional split between a primary cell (PCell) distributed unit (DU) and a secondary cell (SCell) DU for supporting inter-DU carrier aggregation (CA).

FIG. 4 is a diagram illustrating an example of D2 interface management procedures.

FIG. 5 is a diagram illustrating an example of D2 UE management procedures for inter-DU CA.

FIG. 6 is a diagram illustrating an example of D2 user plane operations for inter-DU CA.

FIG. 7 is a diagram illustrating an example associated with priority handling in inter-DU CA.

FIG. 8 is a diagram illustrating an example associated with priority handling for PCell DU driven scheduling in inter-DU CA.

FIG. 9 is a diagram illustrating an example associated with priority handling for SCell DU driven scheduling in inter-DU CA.

FIG. 10 is a diagram illustrating an example associated with medium access control (MAC) control element (MAC-CE) transfer in inter-DU CA.

FIG. 11 is a diagram illustrating an example process performed, for example, at a first DU or an apparatus of a first DU.

FIG. 12 is a diagram illustrating an example process performed, for example, at a first DU or an apparatus of a first DU.

FIG. 13 is a diagram illustrating an example process performed, for example, at a first DU or an apparatus of a first DU.

FIG. 14 is a diagram illustrating an example process performed, for example, at a first DU or an apparatus of a first DU.

FIG. 15 is a diagram of an example apparatus for wireless communication.

### SUMMARY

The systems, methods, and devices of this disclosure each have several innovative aspects, no single one of which is solely responsible for the desirable attributes disclosed herein.

Some aspects described herein relate to a first distributed unit (DU). The first DU may include a processing system. The processing system may include one or more processors and one or more code-storing memories coupled with the one or more processors. The processing system may be configured to cause the first DU to transmit, to a second DU, a data scheduling request for scheduling transmission of data from the second DU to a user equipment (UE) via a secondary cell (SCell) for the UE, and an indication of a priority associated with the UE. The processing system may be configured to cause the first DU to receive, from the second DU, a data request associated with a data transmission from the second DU to the UE via the SCell scheduled in accordance with the data scheduling request and the priority associated with the UE. The processing system may be configured to cause the first DU to transmit, to the second DU, a data response including a transport block for the data transmission from the second DU to the UE via the SCell.

Some aspects described herein relate to a first DU. The first DU may include a processing system. The processing system may include one or more processors and one or more code-storing memories coupled with the one or more processors. The processing system may be configured to cause the first DU to receive, from a second DU, a data scheduling request for scheduling transmission of data from the first DU to a UE via an SCell for the UE, and an indication of a priority associated with the UE. The processing system may be configured to cause the first DU to schedule a data transmission to the UE via the SCell in accordance with the data scheduling request and the priority associated with the UE. The processing system may be configured to cause the first DU to transmit, to the second DU, a data request associated with the data transmission to the UE via the SCell. The processing system may be configured to cause the first DU to receive, from the second DU, a data response including a transport block for the data transmission to the UE via the SCell.

Some aspects described herein relate to a first DU. The first DU may include a processing system. The processing system may include one or more processors and one or more code-storing memories coupled with the one or more processors. The processing system may be configured to cause the first DU to receive, from a second

DU, a medium access control (MAC) control element (MAC-CE) transfer request including a MAC-CE payload associated with an SCell for a UE. The processing system may be configured to cause the first DU to append the MAC-CE payload to a data buffer associated with the UE. The processing system may be configured to cause the first DU to coordinate scheduling and transmission of the MAC-CE payload to the UE based on the data buffer associated with the UE.

Some aspects described herein relate to a first DU. The first DU may include a processing system. The processing system may include one or more processors and one or more code-storing memories coupled with the one or more processors. The processing system may be configured to cause the first DU to generate a MAC-CE associated with an SCell for a UE. The processing system may be configured to cause the first DU to transmit, to a second DU, a MAC-CE transfer request including a payload of the MAC-CE.

Some aspects described herein relate to a method for wireless communication performed by a first DU. The method may include transmitting, to a second DU, a data scheduling request for scheduling transmission of data from the second DU to a UE via an SCell for the UE, and an indication of a priority associated with the UE. The method may include receiving, from the second DU, a data request associated with a data transmission from the second DU to the UE via the SCell scheduled in accordance with the data scheduling request and the priority associated with the UE. The method may include transmitting, to the second DU, a data response including a transport block for the data transmission from the second DU to the UE via the SCell.

Some aspects described herein relate to a method for wireless communication performed by a first DU. The method may include receiving, from a second DU, a data scheduling request for scheduling transmission of data from the first DU to a UE via an SCell for the UE, and an indication of a priority associated with the UE. The method may include scheduling a data transmission to the UE via the SCell in accordance with the data scheduling request and the priority associated with the UE. The method may include transmitting, to the second DU, a data request associated with the data transmission to the UE via the SCell. The method may include receiving, from the second DU, a data response including a transport block for the data transmission to the UE via the SCell.

Some aspects described herein relate to a method of wireless communication performed by a first DU. The method may include receiving, from a second DU, a MAC-CE transfer request including a MAC-CE payload associated with an SCell for a UE. The method may include appending the MAC-CE payload to a data buffer associated with the UE. The method may include coordinating scheduling and transmission of the MAC-CE payload to the UE based on the data buffer associated with the UE.

Some aspects described herein relate to a method of wireless communication performed by a first DU. The method may include generating a MAC-CE associated with an SCell for a UE. The method may include transmitting, to a second DU, a MAC-CE transfer request including a payload of the MAC-CE.

Some aspects described herein relate to a non-transitory computer-readable medium that stores a set of instructions for wireless communication by a first DU. The set of instructions, when executed by one or more processors of the first DU, may cause the first DU to transmit, to a second DU, a data scheduling request for scheduling transmission of data from the second DU to a UE via an SCell for the UE, and an indication of a priority associated with the UE. The set of instructions, when executed by one or more processors of the first DU, may cause the first DU to receive, from the second DU, a data request associated with a data transmission from the second DU to the UE via the SCell scheduled in accordance with the data scheduling request and the priority associated with the UE. The set of instructions, when executed by one or more processors of the first DU, may cause the first DU to transmit, to the second DU, a data response including a transport block for the data transmission from the second DU to the UE via the SCell.

Some aspects described herein relate to a non-transitory computer-readable medium that stores a set of instructions for wireless communication by a first DU. The set of instructions, when executed by one or more processors of the first DU, may cause the first DU to receive, from a second DU, a data scheduling request for scheduling transmission of data from the first DU to a UE via an SCell for the UE, and an indication of a priority associated with the UE. The set of instructions, when executed by one or more processors of the first DU, may cause the first DU to schedule a data transmission to the UE via the SCell in accordance with the data scheduling request and the priority associated with the UE. The set of instructions, when executed by one or more processors of the first DU, may cause the first DU to transmit, to the second DU, a data request associated with the data transmission to the UE via the SCell. The set of instructions, when executed by one or more processors of the first DU, may cause the first DU to receive, from the second DU, a data response including a transport block for the data transmission to the UE via the SCell.

Some aspects described herein relate to a non-transitory computer-readable medium that stores a set of instructions for wireless communication by a first DU. The set of instructions, when executed by one or more processors of the first DU, may cause the first DU to receive, from a second DU, a MAC-CE transfer request including a MAC-CE payload associated with an SCell for a UE. The set of instructions, when executed by one or more processors of the first DU, may cause the first DU to append the MAC-CE payload to a data buffer associated with the UE. The set of instructions, when executed by one or more processors of the first DU, may cause the first DU to coordinate scheduling and transmission of the MAC-CE payload to the UE based on the data buffer associated with the UE.

Some aspects described herein relate to a non-transitory computer-readable medium that stores a set of instructions for wireless communication by a first DU. The set of instructions, when executed by one or more processors of the first DU, may cause the first DU to generate a MAC-CE associated with an SCell for a UE. The set of instructions, when executed by one or more processors of the first DU, may cause the first DU to transmit, to a second DU, a MAC-CE transfer request including a payload of the MAC-CE.

Some aspects described herein relate to an apparatus for wireless communication. The apparatus may include means for transmitting, to a DU, a data scheduling request for scheduling transmission of data from the DU to a UE via an SCell for the UE, and an indication of a priority associated with the UE. The apparatus may include means for receiving, from the DU, a data request associated with a data transmission from the DU to the UE via the SCell scheduled in accordance with the data scheduling request and the priority associated with the UE. The apparatus may include means for transmitting, to the DU, a data response including a transport block for the data transmission from the DU to the UE via the SCell.

Some aspects described herein relate to an apparatus for wireless communication. The apparatus may include means for receiving, from a DU, a data scheduling request for scheduling transmission of data from the apparatus to a UE via an SCell for the UE, and an indication of a priority associated with the UE. The apparatus may include means for scheduling a data transmission to the UE via the SCell in accordance with the data scheduling request and the priority associated with the UE.

The apparatus may include means for transmitting, to the DU, a data request associated with the data transmission to the UE via the SCell. The apparatus may include means for receiving, from the DU, a data response including a transport block for the data transmission to the UE via the SCell.

Some aspects described herein relate to an apparatus for wireless communication. The apparatus may include means for receiving, from a DU, a MAC-CE transfer request including a MAC-CE payload associated with an SCell for a UE. The apparatus may include means for appending the MAC-CE payload to a data buffer associated with the UE. The apparatus may include means for coordinating scheduling and transmission of the MAC-CE payload to the UE based on the data buffer associated with the UE.

Some aspects described herein relate to an apparatus for wireless communication. The apparatus may include means for generating a MAC-CE associated with an SCell for a UE. The apparatus may include means for transmitting, to a DU, a MAC-CE transfer request including a payload of the MAC-CE.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### Detailed Description

Carrier aggregation (CA) in wireless communications enables the use of multiple component carriers (CCs) (also referred to as “carriers” or “cells”) to be combined (e.g., into a single channel) for a user equipment (UE) to increase the overall data rate and bandwidth available for the UE. In carrier aggregation, a UE 120 may be configured with a primary carrier or primary cell (PCell) and one or more secondary carriers or secondary cells (SCells). An open radio access network (RAN) (O-RAN) architecture may include one or more O-RAN central units (CUs) (O-CUs), which may handle higher-layer protocols, one or more O-RAN distributed units (DUs) (O-DUs), which may manage real-time lower-layer protocols, and one or more O-RAN radio units (RUs) (O-RUs), which may be responsible for radio frequency processing and transmission. “Inter-DU CA” (or “inter-O-DU CA”) refers to CA in which the carriers or cells configured for a UE are managed by different DUs. “PCell DU” (or “PCell O-DU”) refers to a DU that manages the PCell configured for a UE (e.g., a DU that communicates with the UE via the PCell). “SCell DU” (or “SCell O-DU”) refers to a DU that manages one or more SCells for a UE (e.g., a DU that communications with the UE via one or more SCells).

Inter-DU CA involves coordinating operations of these different DUs (e.g., a PCell DU and one or more SCell DUs), which may belong to different vendors or have different implementations, to ensure seamless and efficient communication as if the aggregated carriers were managed by a single DU. The different DUs may have separate medium access control (MAC) entities. In scenarios where the CA involves multiple, possibly heterogeneous, DUs (e.g., with separate MAC entities), coordinating the scheduling of data packets can be a complex task. Each DU may maintain its own scheduling and quality of service (QoS) mechanisms. In such examples, the functional split between the PCell DU and the SCell DU may involve the exchange, via a D2 interface between the PCell DU and the SCell DU, of user data and control information at the MAC level. A single radio link control (RLC) per UE may reside in the PCell DU. The PCell DU may perform physical uplink control channel (PUCCH) allocation and reception of PUCCH information from the UE for both the PCell and the SCell(s), and the PCell DU may share the received PUCCH information for the SCell with the SCell DU via the D2 interface.

In a scenario in which CA uses multiple carriers or cells managed by a single DU, a single MAC typically performs dynamic scheduling (e.g., priority handling between UEs) and logical channel prioritization (e.g., priority handling between logical channels of a UE) for downlink data transmissions to a UE via all of the cells configured for the UE. A single MAC entity can support multiple numerologies, cells, and transmission timings, and mapping restrictions in logical channel prioritization may control which numerologies, cells, and transmission timings a logical channel can use. However, in an inter-DU CA scenario, the PCell DU and the SCell DU(s) may have separate MAC entities, and the dynamic scheduling and logical channel prioritization may be performed separately for the PCell and the SCell(s) configured for a UE. In such inter-DU CA scenarios, the SCell DU may receive data to be transmitted to the UE from the PCell DU at the MAC level, and the SCell DU may not have access to information (e.g., data radio bearer (DRB) information, QoS information, or logical channel information) typically used for dynamic scheduling and logical channel prioritization for the data to be transmitted to the UE by the SCell DU. As a result, the prioritization of downlink data transmissions for a UE may be inconsistent between the PCell and the SCell, and the SCell DU may fail to maintain QoS levels for the data transmissions to the UE via the SCell. Furthermore, in some examples, the SCell DU may generate a MAC control element (CE) (e.g., a MAC-CE related to the SCell) to be transmitted to the UE, and there is currently no mechanism for handling scheduling and transmission of MAC-CEs generated by the SCell DU in an inter-DU CA scenario.

Various aspects relate generally to enhanced coordination and prioritization in inter-DU CA. In some aspects, a first DU (e.g., a PCell DU) may transmit, to a second DU (e.g., an SCell DU), a data scheduling request for scheduling transmission of data from the second DU to a UE via an SCell, and the first DU may transmit, to the second DU, an indication of a priority associated with the UE. The second DU may schedule a data transmission to the UE via the SCell in accordance with the data scheduling request and the priority, and the second DU may transmit, to the first DU, a data request associated with the scheduled data transmission to the UE via the SCell. The first DU may receive the data request associated with the scheduled data transmission to the UE via the SCell, and the first DU may transmit, to the second DU, a transport block for the scheduled data transmission. The second DU may receive the transport block, and the second DU may transmit the transport block in the scheduled data transmission to the UE via the SCell. In some examples, the priority indication can be a specific priority value or a range of priority values. In some examples, the indication of the priority may be included in the data scheduling request. In some other examples, the first DU may transmit the indication of the priority for the UE to the second DU in a UE addition or modification request. The priority information may be used by a scheduler of the second DU in performing dynamic scheduling or logical channel prioritization for the data transmission to the UE via the SCell.

Particular aspects of the subject matter described in this disclosure can be implemented to realize one or more of the following potential technical advantages. By transmitting the priority information, the described techniques can ensure that the network's scheduling algorithms efficiently allocate resources in accordance with the QoS demands of different UEs, thereby optimizing bandwidth utilization and conserving network resources. For example, by the PCell DU transmitting the indication priority associated with the UE to the SCell DU, the SCell DU is enabled to prioritize scheduling of the data transmission to the UE via the SCell to maintain a QoS level associated with the data for the UE. In some examples, by indicating the priority associated with the UE in the data scheduling request, the PCell DU can specify the priority for each data transmission to the UE via the SCell, which enables to the SCell DU to use the indication of the priority for logical channel prioritization to maintain different QoS levels for different data transmissions to the UE. The priority handling strategy described herein facilitates the management of carrier aggregation across different DUs, which is particularly beneficial for maintaining the QoS levels in multi-vendor and heterogeneous network environments.

Some aspects relate to handling scheduling of MAC-CEs generated by an SCell DU. In some aspects, a first DU (e.g., a PCell DU) may receive, from a second DU (e.g., an SCell DU), a MAC-CE transfer request including a MAC-CE payload. For example, the second DU may generate a MAC-CE associated with the SCell for a UE, and the second DU may transmit, to the first DU, the MAC-CE transfer request including the payload of the MAC-CE. The first DU may append the MAC-CE payload to a data buffer for the UE, and the first DU may coordinate the scheduling and transmission of the MAC-CE payload. In this way, MAC-CEs generated by the SCell DU may be scheduled and transmitted to the UE in an inter-DU CA scenario.

By implementing the described techniques, a communication system can dynamically adapt to changing network conditions and UE requirements, which in turn improves network throughput and reduces response times for data transmission. The ability to communicate priority levels and coordinate MAC-CE transfers between DUs enhances the technical performance of the network, leading to more efficient use of radio spectrum and improved overall network capacity.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

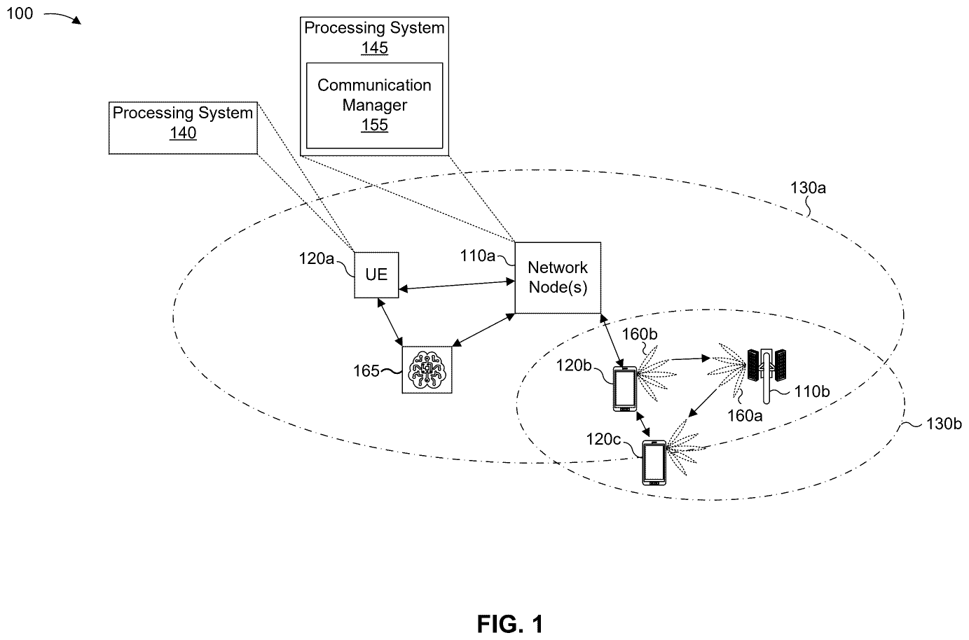

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a RAN. In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more CUs, one or more DUs, and one or more RUs. A CU may host one or more higher layers, such as a radio resource control (RRC) layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a RLC layer, a MAC layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, CCs, subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include PUCCHs, and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In some aspects, the network node 110 (e.g., a DU) may include a communication manager 155. As described in more detail elsewhere herein, the communication manager 155 may transmit, to another network node (e.g., another DU), a data scheduling request for scheduling transmission of data from the other network node to a UE via an SCell for the UE, and an indication of a priority associated with the UE; receive, from the other network node, a data request associated with a data transmission from the other network node to the UE via the SCell scheduled in accordance with the data scheduling request and the priority associated with the UE; and transmit, to the other network node, a data response including a transport block for the data transmission from the second DU to the UE via the SCell.

Additionally, or alternatively, the communication manager 155 may receive, from another network node (e.g., another DU), a data scheduling request for scheduling transmission of data from the network node 110 to a UE via an SCell for the UE, and an indication of a priority associated with the UE; schedule a data transmission to the UE via the SCell in accordance with the data scheduling request and the priority associated with the UE; transmit, to the other network node, a data request associated with the data transmission to the UE via the SCell; and receive, from the other network node, a data response including a transport block for the data transmission to the UE via the SCell.

Additionally, or alternatively, the communication manager 155 may receive, from another network node (e.g., another DU), a MAC-CE transfer request including a MAC-CE payload associated with an SCell for a UE; append the MAC-CE payload to a data buffer associated with the UE; and coordinate scheduling and transmission of the MAC-CE payload to the UE based on the data buffer associated with the UE.

Additionally, or alternatively, the communication manager 155 may generate a MAC-CE associated with an SCell for a UE; and transmit, to another network node (e.g., another DU), a MAC-CE transfer request including a payload of the MAC-CE. Additionally, or alternatively, the communication manager 155 may perform one or more other operations described herein.

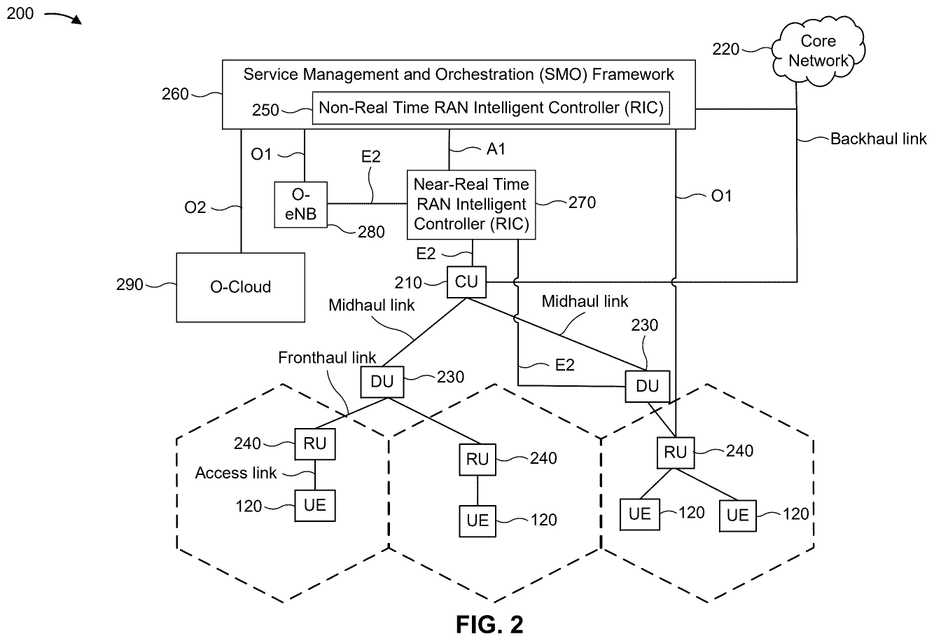

FIG. 2 is a diagram illustrating an example disaggregated network node architecture 200. The disaggregated network node architecture 200 may be implemented in an O-RAN configuration (e.g., a network configuration in compliance with the O-RAN standard promulgated by the O-RAN Alliance). One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a Non-RT RIC 250 associated with an SMO Framework 260 or a Near-RT RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. The DUs 230 may also be referred to as O-DUs 230 when implemented in an O-RAN configuration. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium. In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270. In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with priority handling and

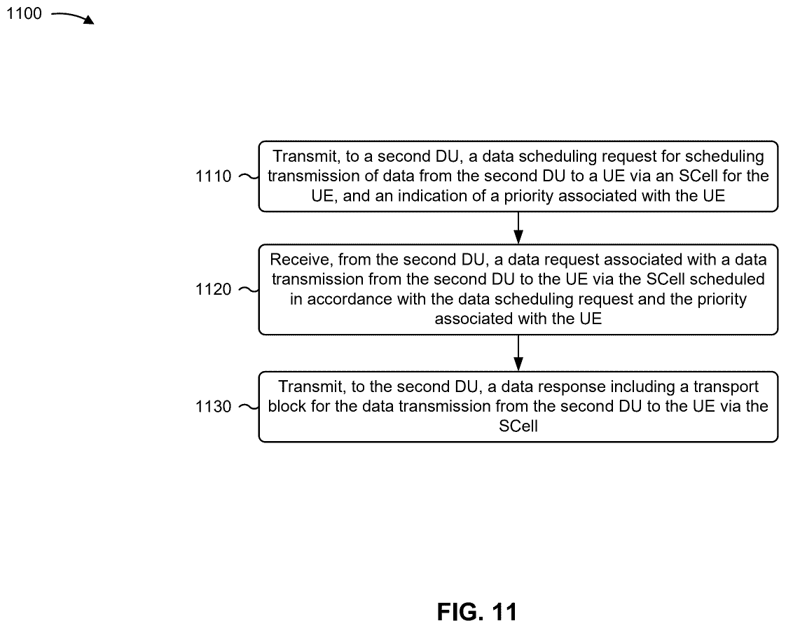

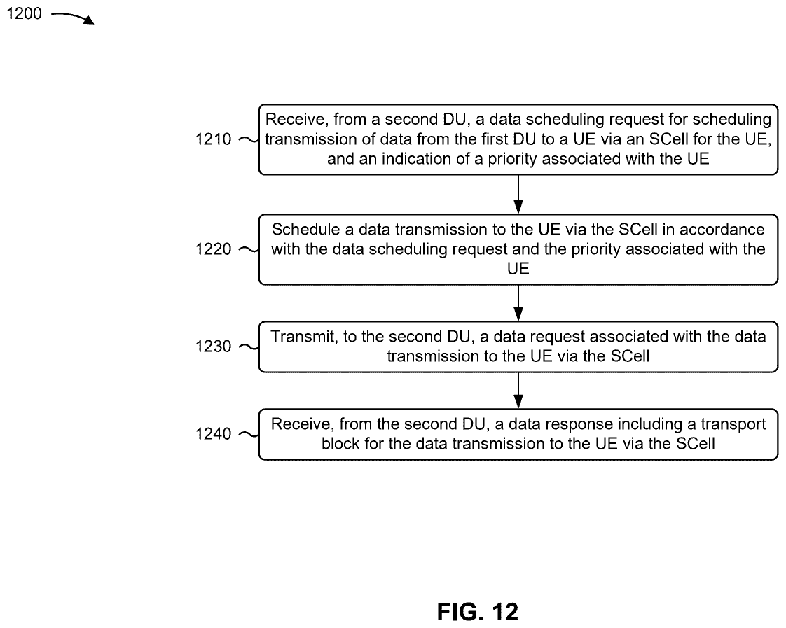

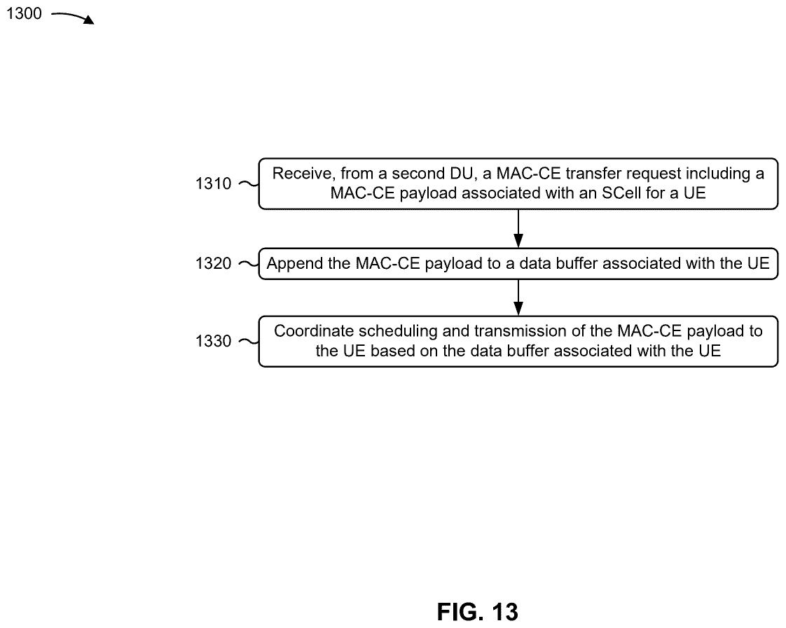

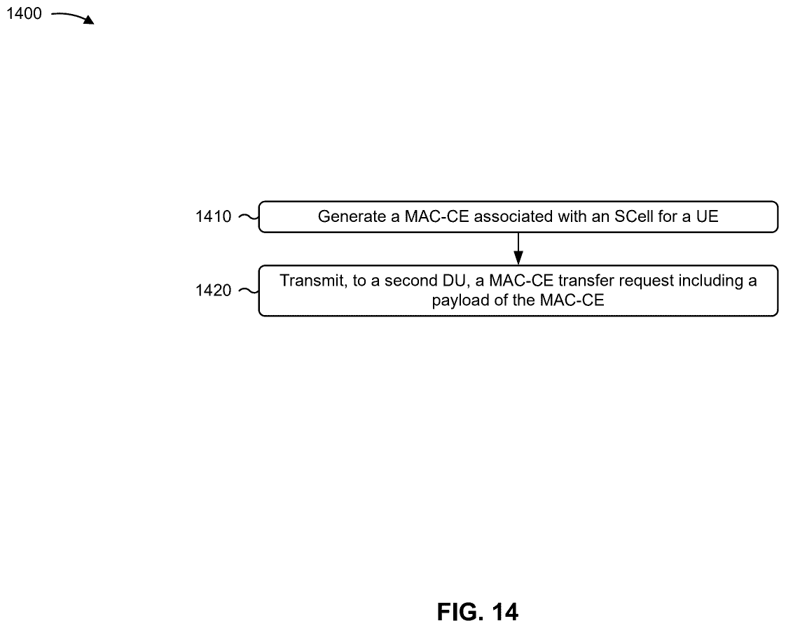

MAC-CE transfer in inter-DU CA, as described in more detail elsewhere herein. For example, the processing system 145 of the network node 110, or the processing system 140 of the UE 120, the CU 210, the DU 230, or the RU 240 may perform or direct operations of, for example, process 1100 of FIG. 11, process 1200 of FIG. 12, process 1300 of FIG. 13, process 1400 of FIG. 14, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 1100 of FIG. 11, process 1200 of FIG. 12, process 1300 of FIG. 13, process 1400 of FIG. 14, or other processes as described herein. In some examples, executing instructions may include running the instructions, converting the instructions, compiling the instructions, or interpreting the instructions, among other examples.

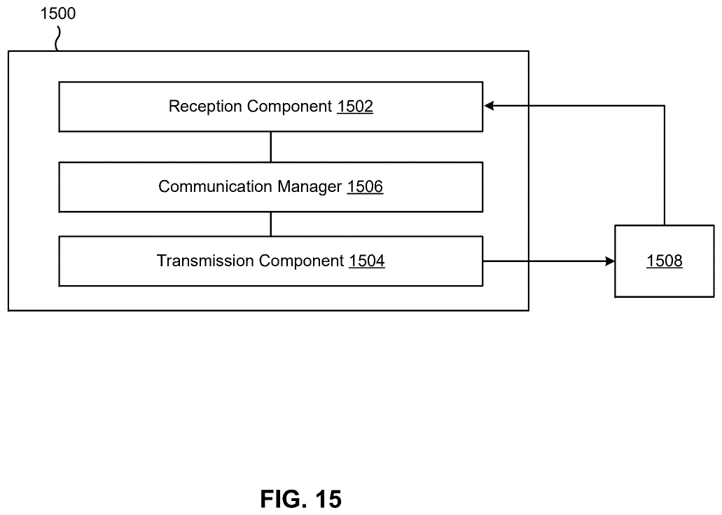

In some aspects, a first DU (e.g., DU 230, network node 110) includes means for transmitting, to a second DU, a data scheduling request for scheduling transmission of data from the second DU to a UE via an SCell for the UE, and an indication of a priority associated with the UE; means for receiving, from the second DU, a data request associated with a data transmission from the second DU to the UE via the SCell scheduled in accordance with the data scheduling request and the priority associated with the UE; or means for transmitting, to the second DU, a data response including a transport block for the data transmission from the second DU to the UE via the SCell. In some aspects, the means for the first DU to perform operations described herein may include, for example, one or more of communication manager 155, processing system 145, a radio, one or more RF chains, one or more transceivers, one or more antennas, one or more modems, a reception component (for example, reception component 1502 depicted and described in connection with FIG. 15), or a transmission component (for example, transmission component 1504 depicted and described in connection with FIG. 15), among other examples.

In some aspects, a first DU (e.g., DU 230, network node 110) includes means for receiving, from a second DU, a data scheduling request for scheduling transmission of data from the first DU to a UE via an SCell for the UE, and an indication of a priority associated with the UE; means for scheduling a data transmission to the UE via the SCell in accordance with the data scheduling request and the priority associated with the UE; means for transmitting, to the second DU, a data request associated with the data transmission to the UE via the SCell; or means for receiving, from the second DU, a data response including a transport block for the data transmission to the UE via the SCell. In some aspects, the means for the first DU to perform operations described herein may include, for example, one or more of communication manager 155, processing system 145, a radio, one or more RF chains, one or more transceivers, one or more antennas, one or more modems, a reception component (for example, reception component 1502 depicted and described in connection with FIG. 15), or a transmission component (for example, transmission component 1504 depicted and described in connection with FIG. 15), among other examples.

In some aspects, a first DU (e.g., DU 230, network node 110) includes means for receiving, from a second DU, a MAC-CE transfer request including a MAC-CE payload associated with an SCell for a UE; means for appending the MAC-CE payload to a data buffer associated with the UE; or means for coordinating scheduling and transmission of the MAC-CE payload to the UE based on the data buffer associated with the UE. In some aspects, the means for the first DU to perform operations described herein may include, for example, one or more of communication manager 155, processing system 145, a radio, one or more RF chains, one or more transceivers, one or more antennas, one or more modems, a reception component (for example, reception component 1502 depicted and described in connection with FIG. 15), or a transmission component (for example, transmission component 1504 depicted and described in connection with FIG. 15), among other examples.

In some aspects, a first DU (e.g., DU 230, network node 110) includes means for generating a MAC-CE associated with an SCell for a UE; or means for transmitting, to a second DU, a MAC-CE transfer request including a payload of the MAC-CE. In some aspects, the means for the first DU to perform operations described herein may include, for example, one or more of communication manager 155, processing system 145, a radio, one or more RF chains, one or more transceivers, one or more antennas, one or more modems, a reception component (for example, reception component 1502 depicted and described in connection with FIG. 15), or a transmission component (for example, transmission component 1504 depicted and described in connection with FIG. 15), among other examples.

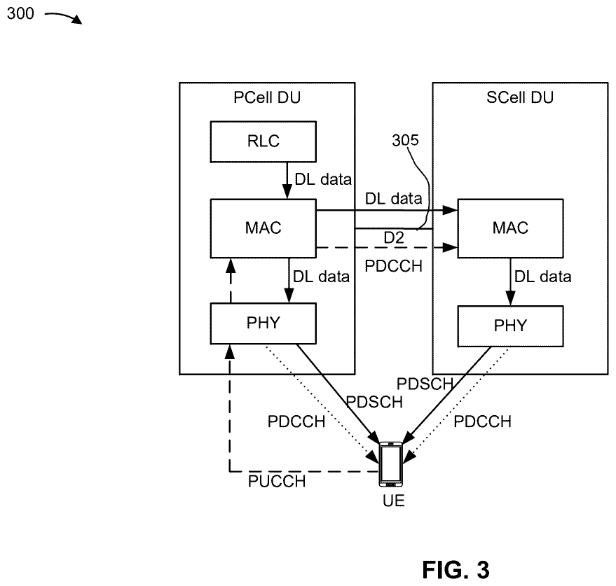

FIG. 3 is a diagram illustrating an example 300 of a functional split between a PCell DU and an SCell DU for supporting inter-DU CA. Example 300 includes a PCell DU (e.g., DU 230), and SCell DU (e.g., DU 230), and a UE (e.g., UE 120). The PCell DU may be associated with a PCell configured for the UE, and the SCell DU may be associated with one or more SCells configured for the UE. That is, the PCell DU may be a DU at which the PCell is configured for the UE for inter-DU CA, and the SCell DU may be a DU at which only SCell(s) (e.g., and not the PCell) are configured for the UE for inter-DU CA. The PCell DU may be an O-DU (e.g., a PCell O-DU), and the SCell DU may be an O-DU (e.g., an SCell O-DU).

As shown in FIG. 3, and by reference number 305, the PCell DU may communicate with the SCell DU via a D2 interface. The D2 interface is a logical interface connecting two DUs (e.g., O-DUs) for supporting inter-DU CA. A pair of DUs (e.g., the PCell DU and the SCell DU) may be connected with each other by the D2 interface. Using D2 interface, the DUs (e.g., the PCell DU and the SCell DU) are able to exchange user data and control information to support inter-DU CA. Accordingly, the D2 interface supports NR carrier aggregation configured in different DU (e.g., O-DU) nodes. In such examples, in which carrier aggregation is configured in different DUs, the schedulers in the DUs (e.g., the PCell DU and the SCell DU) operate independently of each other.

As shown in FIG. 3, the PCell DU and the SCell DU have separate MAC entities, and the user data and control information message exchange between the PCell DU and the SCell DU (e.g., via the D2 interface) takes place at the MAC level. A single RLC entity per UE may reside in the PCell DU. In some examples, the RLC entity provides downlink data for the UE to the MAC layer of the PCell DU. The MAC layer of PCell DU may allocate some downlink data to be transmitted to the UE via the PCell. This downlink data may be provided to the PHY layer of the PCell DU, and the PHY layer of the PCell DU may transmit PDSCH communications including the downlink data, as well as PDCCH communications, to the UE via the PCell. The MAC layer of the PCell DU may also allocate some downlink data to be transmitted to the UE via the PCell. The MAC layer of the PCell DU may provide this downlink data to the MAC layer of the SCell DU via the D2 interface, and the MAC layer of the SCell DU may schedule a transmission of downlink data to the UE via the SCell. The scheduling of the transmission of downlink data includes the SCell DU MAC layer selecting the time and frequency resources, the MCS, the number of layers, and the precoder for the transmission of downlink data. The scheduling grant, determined by the SCell DU MAC layer, determines the size of a TB to be transmitted to the UE in the scheduled transmission. The PCell DU MAC layer prepares/generates the TB based on the scheduling decisions determined by the SCell DU and provides the TB to the SCell DU. The MAC layer of the SCell may then provide the downlink data (e.g., the TB) to the PHY layer of the SCell, and the PHY layer of the SCell may transmit the PDSCH communications including the downlink data, as well as PDCCH communications, to the UE via the SCell. In some examples, to support downlink carrier aggregation using the D2 interface, the PCell DU may perform PUCCH allocation and reception, from the UE, of PUCCH data for both the PCell and the SCell(s). In such examples, the UE may transmit PUCCH information (e.g., HARQ feedback or CSI, among other examples) for both the PCell and the SCell(s) to the PCell DU via the PCell. As shown in FIG. 3, the PCell DU may receive the PUCCH information for both the PCell and the SCell(s) from the UE, and the PCell DU may share (e.g., via the D2 interface), the PUCCH information for the SCell(s) with the SCell DU.

As indicated above, FIG. 3 is provided as an example. Other examples may differ from what is described with respect to FIG. 3.

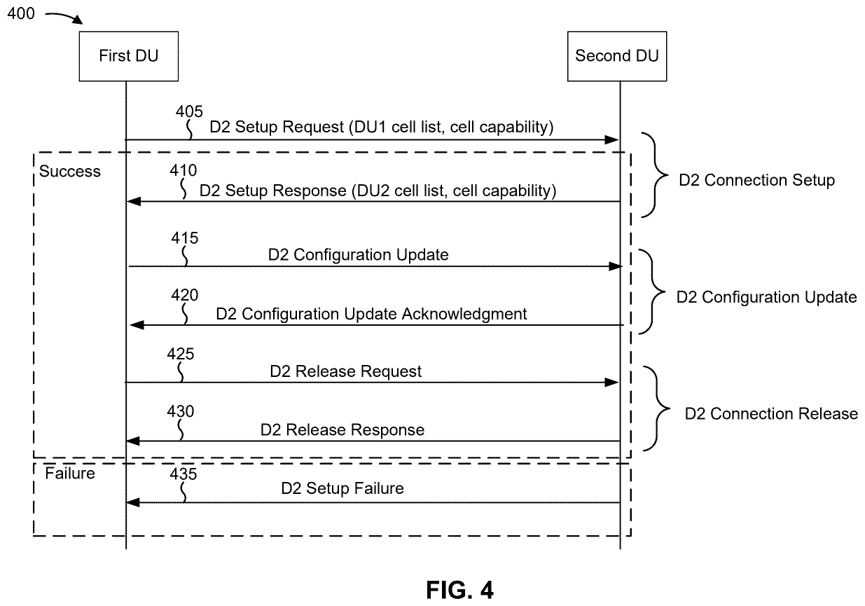

FIG. 4 is a diagram illustrating an example 400 of D2 interface management procedures. As shown in FIG. 4, example 400 includes a first DU (e.g., DU 230) and a second DU (e.g., DU 230). The first DU may be a first O-DU, and the second DU may be a second O-DU. The functionality of the D2 interface may include D2 control plane (D2-C) functions and D2 user plane (D2-U) functions. The procedures shown in example 400 are performed using D2-C interface management functions.

A D2 connection setup procedure uses a D2 setup function to establish an initial connection between two DUs via the D2 interface. The D2 setup function enables the initial setup of a D2 connection between two DUs, including an exchange of the cell-level data. Configuration of the D2 interface endpoints may be managed by the SMO (e.g., SMO framework 260) and provided to the DUs via the O1 interface. D2 configuration may also be provided through node-specific orchestration and management (O&M) systems. The D2 connection setup procedure can be initiated by any DU that successfully completes a cell setup procedure. During this D2 connection setup procedure, both the originating and destined O-DUs share cell capabilities, such as sub-carrier spacing, duplexing methods, and time division duplex (TDD) DL-UL configurations, among other examples.

In example 400, the first DU is initiating the D2 connection setup procedure. As shown by reference number 405, the first DU may transmit, and the second DU may receive, a D2 setup request. The D2 setup request may include a cell list associated with the first DU and cell capability information associated with the first DU. The cell list associated with the first DU may include a list of cells configured for the first DU. The cell capability information associated with the first DU may include cell capabilities, such as sub-carrier spacing, duplexing methods, or TDD DL-UL configurations, among other examples, for the cells in the cell list associated with the first DU. As shown by reference number 410, the second DU may transmit, and the first DU may receive, a D2 setup response. For example, the second DU may transmit the D2 setup response in response to receiving the D2 setup request from the first DU. The D2 setup response may include a cell list associated with the second DU and cell capability information associated with the second DU. The cell list associated with the second DU may include a list of cells configured for the second DU. The cell capability information associated with the second DU may include cell capabilities, such as sub-carrier spacing, duplexing methods, or TDD DL-UL configurations, among other examples, for the cells in the cell list associated with the second DU. In some examples, the second DU may transmit the D2 setup response in a case in which the D2 setup procedure is successful in establishing the D2 connection between the first DU and the second DU.

Once the D2 connection is established between the two DUs, any changes in the cells supported by a DU, such as a cell being locked, a cell being unlocked, a cell being overloaded, or any other change in the cells supported by the DU, may be communicated to the other DU using the D2 configuration update procedure. This procedure allows the two O-DUs to notify each other about changes in their cell status. For example, as shown by reference number 415, the first DU may transmit, and the second DU may receive, a D2 configuration update. The DU configuration update may indicate a change in the status of the cells supported by the first DU, such as a cell being locked, unlocked, or overloaded, among other examples. As shown by reference number 420, the second DU may transmit, and the first DU may receive, a D2 configuration acknowledgment, which acknowledges reception of the D2 configuration update. In a case in which the cell status for a cell (e.g., an SCell) is locked or disabled, context for all of the UEs in that cell will be released. For example, if the D2 configuration update received by the second DU indicates that a cell was locked or disabled, the second DU may release the context for all UEs in that cell based on the D2 configuration update.

The D2 connection release procedure uses a D2 release function to remove/release the D2 connection between the two DUs. For example, as shown by reference number 425, the first DU may transmit, and the second DU may receive, a D2 release request. The first DU may transmit the DU release request responsive to a decision, by the first DU, to release the D2 connection between the first DU and the second DU. As shown by reference number 430, the second DU may transmit, and the first DU may receive, a D2 release response in connection with receiving the D2 release request. Once the second DU transmits the DU release response to the first DU, the D2 connection between the first DU and the second DU is released, and all related resources between the two DUs may be cleared in a controlled manner. For example, all D2 contexts may be cleared, a stream control transmission protocol (SCTP) connection may be released, and no further messages may be exchanged between the first DU and the second DU over the D2 connection.

An error indication function may be used by a DU to indicate to the other DU that an error has occurred. For example, if parsing of a D2 configuration update acknowledge or a D2 setup response fails, a DU can inform the other DU about the failure using the error indication function. As shown by reference number 435, the second DU may transmit, and the first DU may receive, a D2 setup failure message to indicate failure of the D2 connection setup procedure. For example, the second DU may transmit the D2 setup failure message to the first DU in response to a failure to successfully parse the D2 setup request transmitted from the first DU.

As indicated above, FIG. 4 is provided as an example. Other examples may differ from what is described with regard to FIG. 4.

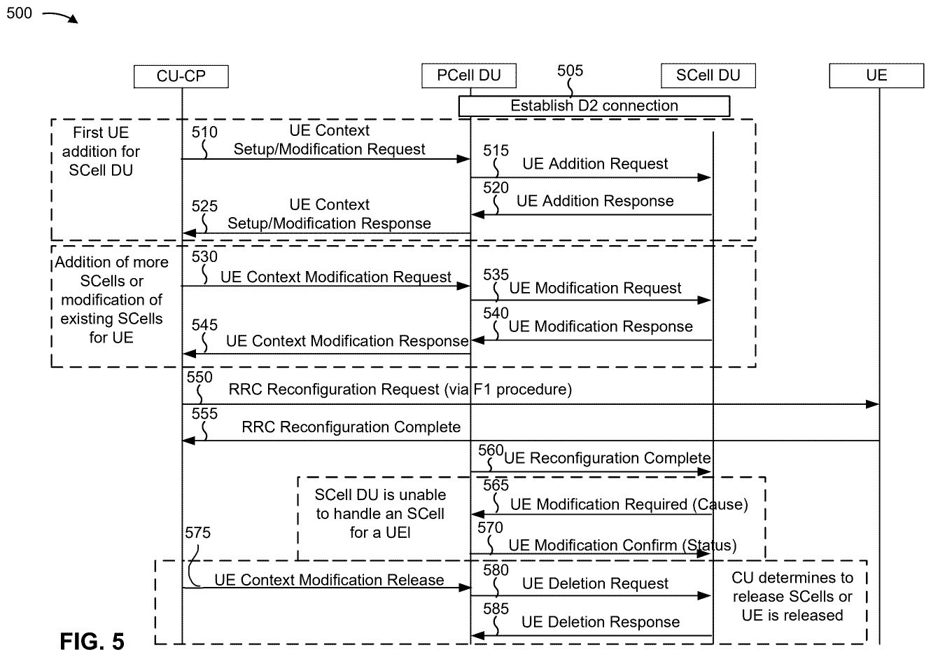

FIG. 5 is a diagram illustrating an example 500 of D2 UE management procedures for inter-DU CA. As shown in FIG. 5, example 500 includes a PCell DU (e.g., DU 230), an SCell DU (e.g., DU 230), a CU (e.g., CU 210) control plane (CU-CP), and a UE (e.g., UE 120). The PCell DU may be associated with a PCell configured for the UE (e.g., the PCell DU may manage the PCell configured for the UE and communicate with the UE via the PCell), and the SCell DU may be associated with an SCell (or multiple SCells) configured for the UE (e.g., the SCell DU may manage the SCell(s) configured for the UE and communicate with the UE via the SCell(s)). The PCell DU may be an O-DU (e.g., a PCell O-DU), the SCell DU may be an O-DU (e.g., an SCell O-DU), and the CU may be an O-CU (e.g., an O-CU-CP). The UE management procedures shown in example 500 are performed using D2-C UE management functions that support the establishment and modification of D2 context for SCells for a UE. The UE management functions include establishment, modification, and release of SCells in the PCell DU and the SCell DU, and the UE management procedures include procedures for addition, modification, and deletion of an SCell for a UE in the PCell DU and the SCell DU.

As shown in FIG. 5, and by reference number 505 the PCell DU and the SCell DU may establish a D2 connection between the PCell DU and the SCell DU. The PCell DU and the SCell DU may establish the D2 connection using the D2 connection setup procedure described above in connection with FIG. 4. The PCell DU and the SCell DU may establish the D2 connection prior to performing the UE management procedures shown, and the PCell DU and the SCell DU may communicate via the D2 interface to perform the UE management procedures.

As shown by reference number 510, in a UE addition procedure used for the addition of a first SCell for a UE at the SCell DU, the CU-CP may transmit, and the PCell DU may receive, a UE context setup or modification request. As shown by reference number 515, the PCell DU may transmit, and the SCell DU may receive, a UE addition request. The PCell DU may transmit the UE addition request in response to receiving the UE context setup or modification request. The UE addition request is initiated by the PCell DU to establish an SCell for a UE at an SCell DU (e.g., to establish the first SCell, at the SCell DU, for the UE). The UE addition request may be accepted or rejected by the SCell DU based on admission control criteria, such as resource availability or loading, among other examples. As shown by reference number 520, the SCell DU may transmit, and the PCell DU may receive, a UE addition response. The UE addition response may indicate whether the SCell DU accepts or rejects the UE addition request. As shown by reference number 525, in connection with the PCell DU receiving a successful UE addition response for the UE from the SCell DU, the PCell DU may transmit a UE context setup or modification response to the CU-CP.

As further shown in FIG. 5, once at least one SCell for the UE is established at (e.g., added to) the SCell DU, a modification procedure may be used for the addition of more SCells for the UE to the SCell DU or the modification of existing SCells for the UE at the SCell DU. As shown by reference number 530, the CU-CP may transmit, and the PCell DU may receive, a UE context modification request. As shown by reference number 535, the PCell DU may transmit, and the SCell DU may receive, a UE modification request. The PCell DU may transmit the UE modification request to the SCell DU in response to receiving the UE context modification request. The UE modification request is initiated by the PCell DU to modify the SCell configuration for the UE. If an SCell for the UE is already configured in the SCell DU, the PCell DU may use the UE modification request to add another SCell for the UE. The UE modification request may also be used by the PCell DU to update any configuration parameters for the UE in the SCell. For example, the UE modification request may indicate a change of security key, a change of uplink configuration, a change of discontinuous reception (DRX) cycle, a change in measurement gap, a PDU session add, release, or modification, a QoS flow add or release, a 5G QoS identifier (5QI) change, or a DRB change, among other examples, in the SCell DU. If multiple SCells are added between the two DUs for a UE, the UE modification request can also be used to release some of the SCells. As shown by reference number 540, the SCell DU may transmit, and the PCell DU may receive a UE modification response. As shown by reference number 545, in connection with the PCell DU receiving the UE modification response from the SCell DU, the PCell DU may transmit a UE context modification response to the CU-CP.

Once an SCell is added for the UE (e.g., via the UE addition procedure or the UE modification procedure), and the CU-CP receives the UE context setup or modification response, RRC reconfiguration is triggered for the UE to configure the UE with the added SCell. As shown by reference number 550, the CU-CP may transmit, to the UE (e.g., via an F1 procedure), an RRC reconfiguration request. As shown by reference number 555, the UE may transmit, and the CU-CP may receive, an RRC reconfiguration complete message in connection with the UE receiving the RRC reconfiguration request. As shown by reference number 560, once the RRC reconfiguration complete message is received from the UE, the PCell DU may transmit a UE reconfiguration complete message to the SCell DU.

As further shown in FIG. 5, a modification required procedure may be used in a case in which the SCell DU is unable to handle an SCell for a UE. As shown by reference number 565, the SCell DU may transmit, and the PCell DU may receive, a UE modification required message. The UE modification required message may be initiated by the SCell DU to request the release of one or more SCells for a UE. The UE modification required message may be triggered due to a scenario taking place in the SCell DU. For example, the UE modification required message may be triggered based on overloading of a cell, or a cell being locked, or a cell being down, among other examples. The UE modification required message may indicate the cause of the request release of the SCell for the UE. The PCell DU, responsive to receiving the modification required message, may remove the SCell for the UE for which the modification required message is received. As shown by reference number 570, the PCell DU may transmit, to the SCell DU, a UE modification confirm message after successful deletion of SCell(s) for the UE. The SCell DU may clear the SCell(s) for the UE in connection with receiving the UE modification confirm message.

As further shown in FIG. 5, a UE deletion procedure may be used if the UE is released in the PCell DU or all of the SCells for the UE are released. As shown by reference number 575, the CP-CU may transmit, to the PCell DU, a UE content modification release message. The UE content modification release message may indicate that the UE is released or all of the SCells for the UE are released. As shown by reference number 580, the PCell DU may transmit, and the SCell DU may receive, a UE deletion request. The UE information for the SCell(s) may be cleared in the SCell DU in connection with the SCell DU receiving the UE deletion request. As shown by reference number 585, the SCell DU may transmit a UE deletion response to the PCell DU in connection with receiving the UE deletion request.

As indicated above, FIG. 5 is provided as an example. Other examples may differ from what is described with respect to FIG. 5.

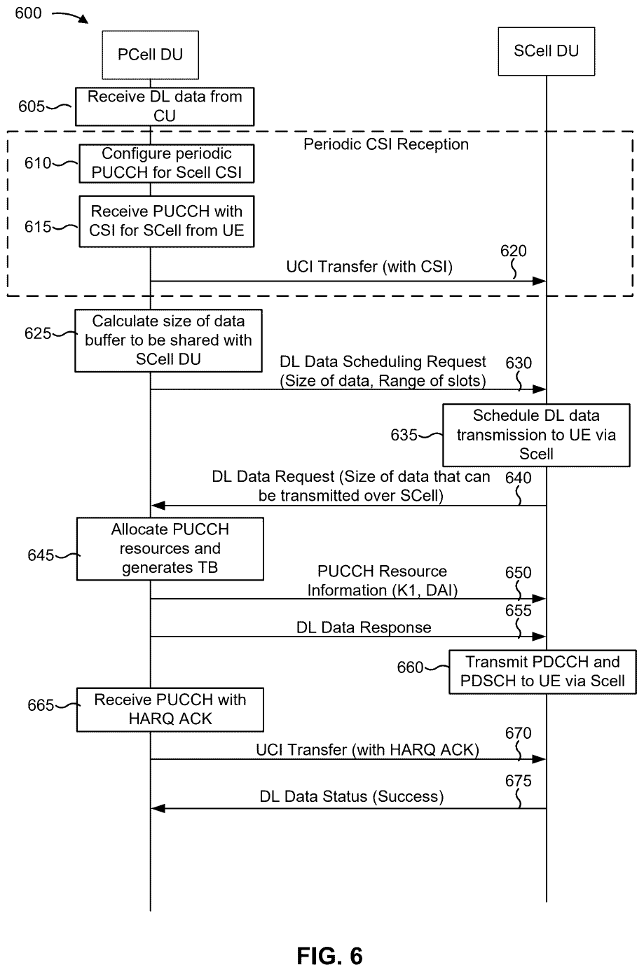

FIG. 6 is a diagram illustrating an example 600 of D 2 user plane operations for inter-DU CA. As shown in FIG. 6, example 600 includes a PCell DU and an SCell DU. The PCell DU may be an O-DU (e.g., a PCell O-DU), and the SCell DU may be an O-DU (e.g., an SCell O-DU). The PCell DU may be associated with a PCell configured for a UE, and the SCell DU may be associated with an SCell (or multiple SCells) configured for the UE. The PCell DU and the SCell DU may communicate via the D2 interface. The PCell DU and the SCell DU may have established a D2 connection (e.g., using the D2 connection establishment procedure described above in connection with FIG. 4) and added one or more SCells for the UE (e.g., using the addition or modification procedure described above in connection with FIG. 5) prior to the operations shown in example 600.

As shown in FIG. 6, and by reference number 605, the PCell DU may receive, from a CU (e.g., from the CU-UP), downlink data for the UE (e.g., downlink data to be transmitted to the UE).

As shown by reference number 610, the PCell DU may configure the UE with periodic PUCCH resources for reporting CSI for the SCell. For example, the SCell DU may transmit periodic CSI-RSs on the SCell, and the PCell DU may transmit, to the UE, configuration information that configures the UE to monitor the periodic CSI-RSs transmitted on the SCell and periodically report CSI for the SCell that is based on the measurements of the CSI-RSs transmitted on the SCell. The configuration information may allocate PUCCH resources on the PCell for periodic reporting of the CSI for the SCell. As shown by reference number 615, the PCell DU may receive, from the UE on the PCell, PUCCH transmissions including the CSI for the SCell. For example, the PCell DU may receive periodic PUCCH transmissions including the CSI for the SCell in the periodic PUCCH resources allocated, on the PCell, for reporting the CSI for the SCell. In some examples, the CSI may include one or more of a CQI, a PMI, an RI, an LI, a CRI, an SSBRI, or measurement information, among other examples. As shown by reference number 620, the PCell DU may transmit, and the SCell DU may receive, a UCI transfer message that includes the CSI for the SCell. For example, the UCI transfer message may include one or more of a CQI, a PMI, an RI, an LI, a CRI, an SSBRI, or measurement information, among other examples, for the SCell. The UCI transfer function (e.g., the UCI transfer message) enables one DU to share relevant UCI received by that DU with another DU. For example, in the downlink inter-DU CA scenario, PUCCH information (e.g., including CSI and HARQ feedback) for all of the SCells may be received from the UE by the PCell DU on the PCell, and the PCell DU may use the UCI transfer function to share the PUCCH for the SCells with one or more SCell DUs.

As shown by reference number 625, the PCell DU may calculate the size of a data buffer, for the UE, to be shared with the SCell DU. For example, the PCell DU may calculate the data size that can be scheduled by the SCell DU for transmission to the UE via the SCell based on various factors including the amount of data to be transmitted and current network conditions.

As shown by reference number 630, the PCell DU may transmit, and the SCell DU may receive, a downlink data scheduling request. The downlink data scheduling request is a request for the SCell DU to schedule a downlink data transmission to the UE via the SCell. The downlink data scheduling request may indicate the size of the data (e.g., in bytes) that can be scheduled by the SCell DU for transmission to the UE via the SCell, and a range of slots in which the data transmission to the UE via the SCell is to be scheduled. Accordingly, to facilitate inter-DU CA, the PCell DU shares with the SCell DU, via the data scheduling request, the amount of downlink data (e.g., the data size) that can be scheduled by the SCell DU for transmission to the UE via the SCell and the range of slots in which the transmission of the downlink data to the UE via the SCell is to be scheduled by the SCell DU.

As shown by reference number 635, the SCell DU may schedule a downlink data transmission to the UE via the SCell based at least in part on the downlink data scheduling request. For example, in connection with receiving the downlink data scheduling request, the SCell DU may determine whether the SCell DU is able to schedule a downlink data transmission to the UE via the SCell in accordance with the downlink data scheduling request. Based on a determination that the SCell DU is able to schedule the downlink data transmission, the SCell DU may determine the actual data size that can be scheduled for transmission the UE via the SCell. The SCell DU may schedule (e.g., allocate resources on the SCell for) a PDSCH transmission of a certain data size (e.g., up to the data size indicated in the downlink data request) and with a certain timing (e.g., within the range of slots indicated in the downlink data scheduling request). The SCell DU may also schedule (e.g., allocate resources on the SCell for) an accompanying PDCCH transmission that includes DCI associated with the PDSCH transmission.

As shown by reference number 640, the SCell DU may transmit, and the PCell DU may receive, a downlink data request. The downlink data request is a request for the downlink data to be transmitted to the UE in the scheduled downlink data transmission via the SCell. The downlink data request may indicate the data size of the scheduled downlink data transmission on the SCell (e.g., the actual data size that can be transmitted via the SCell). The downlink data request may also indicate the scheduled PDCCH slot timing.

As shown by reference number 645, the PCell DU may allocate PUCCH resources associated with the scheduled downlink data transmission on the SCell and generate a TB for the scheduled downlink data transmission on the SCell. The PCell DU may allocate the PUCCH resources and generate the TB based on the downlink data request. The PCell DU may generate the TB based at least in part on the data size of the scheduled downlink data transmission. For example, the PCell may generate a TB of the data size indicated in the downlink data request. The PCell DU may allocate the PUCCH resources associated with the scheduled downlink data transmission on the SCell based at least in part on the PDCCH slot timing indicated in the downlink data request. For example, the PCell DU may allocate PUCCH resources on the PCell for transmission, by the UE, of HARQ feedback associated with the scheduled PDSCH transmission on the SCell.

As shown by reference number 650, the PCell DU may transmit, and the SCell DU may receive, PUCCH resource information associated with the PUCCH resources allocated by the PCell DU. For example, the PUCCH resource information may indicate a K1 value (e.g., a PDSCH-to-ACK/NACK timing offset) and a downlink assignment index (DAI) associated with the allocated PUSCH resources.

As shown by reference number 655, the PCell DU may transmit, and the SCell DU may receive, a downlink data response. The downlink data response may include the TB to be transmitted to the UE in the scheduled downlink data (e.g., PDSCH) transmission on the SCell. The data transfer function (e.g., the downlink data response) enables the transfer of user data between DUs to support inter-DU CA. For downlink inter-DU CA, the PCell DU may transmit user data for the UE to the SCell DU using the data transfer function. In some examples, in a case in which there is a PUCCH resource allocation failure or unavailability of data, the PCell DU may transmit a failure message to the SCell DU.

As shown by reference number 660, the SCell DU may transmit the scheduled downlink transmissions, including the PDSCH transmission and the accompanying PDCCH transmission, to the UE via the SCell. The PDCCH transmission may include the PUCCH resource information (e.g., the K1 value and the DAI) received from the PCell DU. The PDSCH transmission may include the TB (e.g., including the user data) received from the PCell DU in the downlink data response.

As shown by reference number 665, the PCell DU may receive, from the UE on the PCell, a PUCCH transmission including a HARQ ACK associated with the downlink data transmission (e.g., the PDSCH transmission) on the SCell. The UE may transmit HARQ feedback (e.g., HARQ ACK/NACK feedback) associated with the downlink data transmission via the allocated PUCCH resources indicated by the PUCCH resource information included in the PDCCH transmission. For example, the UE may transmit a HARQ ACK in connection with successfully receiving and decoding the downlink data transmission. The PCell DU may receive the PUCCH transmission including the HARQ feedback in the allocated PUCCH resources on the PCell that are indicated in the PDCCH transmission transmitted by the SCell DU via the SCell.

As shown by reference number 670, the PCell DU may transmit, and the SCell DU may receive, a UCI transfer message that includes the HARQ feedback (e.g., the HARQ ACK) associated with the downlink data transmission via the SCell. As shown by reference number 675, the SCell DU may transmit, and the PCell DU may receive, a downlink data status message that indicates a status of the downlink data transmission via the SCell. For example, the SCell DU may transmit, to the PCell DU, a downlink data status message indicating success in connection with receiving the UCI transfer message including the HARQ ACK.

As indicated above, FIG. 6 is provided as an example. Other examples may differ from what is described with respect to FIG. 6.

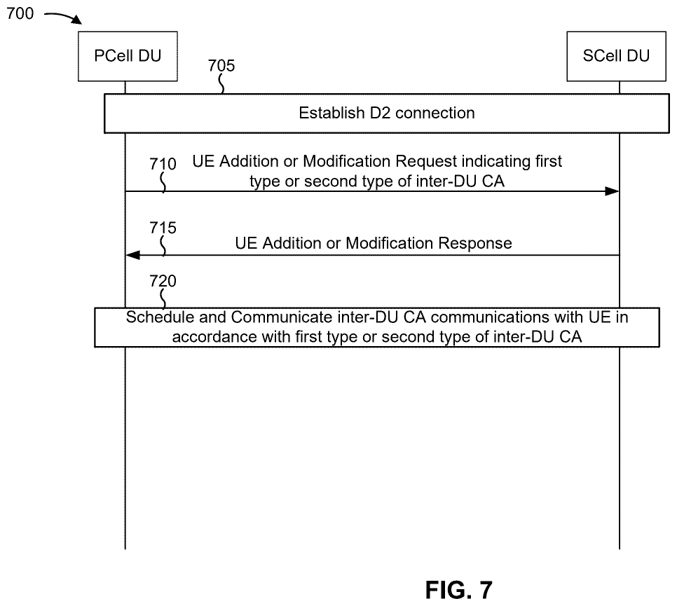

FIG. 7 is a diagram illustrating an example 700 associated with priority handling in inter-DU CA. As shown in FIG. 7, example 700 includes communication between a PCell DU (e.g., DU 230) and an SCell DU (e.g., DU 230). In some aspects, the PCell DU may be an O-DU (e.g., a PCell O-DU), and the SCell DU may be an O-DU (e.g., an SCell O-DU). The PCell DU may be associated with a PCell configured for a UE, and the SCell DU may be associated with an SCell (or multiple SCells) configured for the UE. That is, the PCell DU may manage the PCell for the UE and communicate with the UE via the PCell, and the SCell UE may manage the SCell (or multiple SCells) for the UE and communicate with the UE vial the SCell. The PCell DU and the SCell DU may communicate via an inter-DU interface, such as the D2 interface.

As shown in FIG. 7, and by reference number 705, the PCell DU and the SCell DU may establish a D2 connection between the PCell DU and the SCell DU. The PCell DU and the SCell DU may establish the D2 connection using the D2 connection setup procedure described above in connection with FIG. 4. In some examples, the PCell DU may be the initiating DU that sends the D2 setup request to the SCell DU, and receives the D2 setup response from the SCell DU. In some other examples, the SCell DU may be the initiating DU that sends the D2 setup request to the PCell DU, and receives the D2 setup response from the PCell DU.

As further shown in FIG. 7, and by reference number 710, the PCell DU may transmit, and the SCell DU may receive, a UE addition or modification request that indicates a first type of inter-DU CA or a second type of inter-DU CA. For example, in a UE addition procedure to establish an initial SCell for a UE at the SCell DU, the PCell DU may transmit, to the SCell DU, a UE addition request that indicates the first type of inter-DU CA or the second type of inter-DU CA. Additionally, or alternatively, in a UE modification procedure to add one or more additional SCells for the UE to the SCell DU or to modify one or more existing SCells for the UE at the SCell DU, the PCell DU may transmit, to the SCell DU, a UE modification request that indicates the first type of inter-DU CA or the second type of inter-DU CA.

The first type of inter-DU CA may be associated with PCell DU driven scheduling. The first type of inter-DU CA may also be referred as “Type 1,” “Option 1,” or “PCell DU driven scheduling.” In Option 1, the PCell DU is responsible for maintaining QoS for downlink data transmitted to the UE via the PCell and the SCell, and the PCell DU does not disclose any DRB information to the SCell DU. In Option 1, the PCell O-DU handles logical channel prioritization (e.g., prioritization between logical channels of a UE), and the SCell DU handles dynamic scheduling (e.g., prioritization between UEs) for downlink data transmissions on the SCell without QoS-level information. In some aspects, in Option 1, the downlink data scheduling request may indicate a buffer size and a priority per UE to be used by the SCell DU for dynamic scheduling. In some aspects, in Option 1, the SCell DU indicates the request TB size in the downlink data request, and the PCell DU manages multiplexing of data (e.g., from different logical channels) when generating the TB to be transmitted by the SCell DU via the SCell.

The second type of inter-DU CA may be associated with SCell DU driven scheduling. The second type of inter-DU CA may also be referred as “Type 2,” “Option 2,” or “SCell DU driven scheduling.” In Option 2, the PCell DU shares DRB-level information for some DRBs with the SCell DU, and the SCell DU is responsible for maintaining QoS for those DRBs. In Option 2, the PCell DU delegates one or more DRBs to the SCell DU, and the SCell DU is responsible for maintain QoS for the DRBs delegated to the SCell DU. In Option 2, the PCell DU may provide, to the SCell DU, a list of DRBs with associated QoS parameters and logical channel identifiers (LCIDs). In Option 2, the PCell DU handles logical channel prioritization, the SCell DU handles dynamic scheduling for transmission via the SCell with QoS-level information, and the PCell DU handles multiplexing. In some aspects, in Option 2, in the downlink data scheduling request, the PCell DU may indicate granular information, such as buffer size per LCID (or DRB) per UE. In some aspects, in Option 2, the SCell DU may indicate a requested TB size and a multiplexing instruction (e.g., how many bits per LCID are to be multiplexed into the TB) in the downlink data request, and the PCell DU may manage multiplexing of the TB guided by the multiplexing instruction received from the SCell DU in the downlink data request.

In some examples, the UE addition request or the UE modification request may include an explicit indication of the first type of inter-DU CA (Option 1) or the second type of inter-DU CA (Option 2). In some other examples, the UE addition request or the UE modification request may implicitly indicate a selection of the first type of inter-DU CA (Option 1) or the second type of inter-DU CA (Option 2). For example, the PCell DU may include, in the UE addition request or the UE modification request, DRB information, such as a list of DRBs with associated QoS parameters and LCIDs, and the SCell DU may interpret the inclusion of the DRB information as an indication of the second type of inter-DU CA (Option 2). Alternatively, the UE addition request or the UE modification request not including DRB information may be an indication of the first type of inter-DU CA (Option 1).

As further shown in FIG. 7, and by reference number 715, the SCell DU may transmit, and the PCell DU may receive, a UE addition or modification response. The SCell DU may transmit the UE addition or modification response in connection with receiving the UE addition or modification request from the PCell DU.

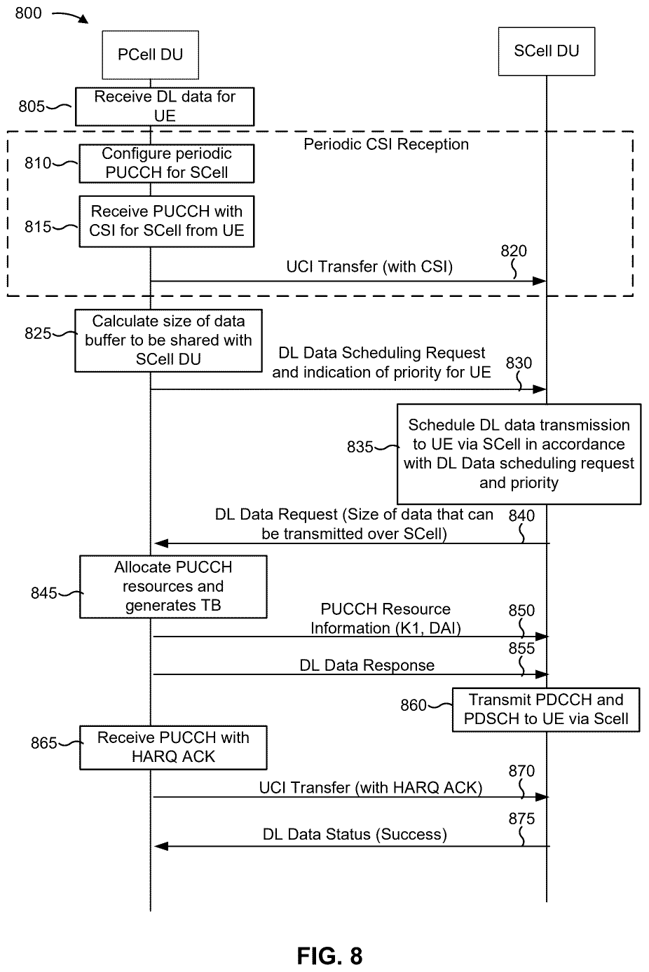

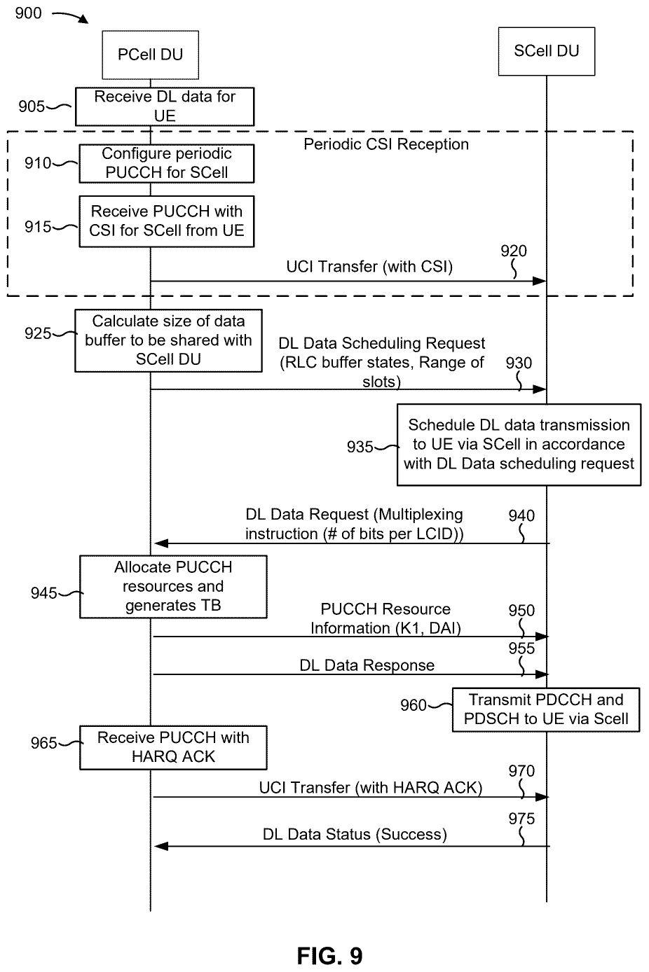

As further shown in FIG. 7, and by reference number 720, the PCell DU and the SCell DU may schedule and communicate inter-DU CA communications with the UE in accordance with the first type of inter-DU CA (Option 1) or the second type of inter-DU CA (Option 2) based on whether the first type of inter-DU CA (Option 1) or the second type of inter-DU CA (Option 2) is indicated in the UE addition or modification request. In some aspects, the PCell DU and the SCell DU may perform operations described below in connection with FIG. 8 based on the UE addition or modification request indicating the first type of inter-DU CA (Option 1 ). For example, the PCell DU may transmit, to the SCell DU, an indication of a priority for a UE in connection with the UE addition or modification request indicating the first type of inter-DU CA (Option 1 ). In some aspects, the PCell DU and the SCell DU may perform operations described below in connection with FIG. 9 based on the UE addition or modification request indicating the second type of inter-DU CA (Option 2 ).

As indicated above, FIG. 7 is provided as an example. Other examples may differ from what is described with respect to FIG. 7.

FIG. 8 is a diagram illustrating an example 800 associated with priority handling for PCell DU driven scheduling in inter-DU CA. As shown in FIG. 8, example 800 includes communication between a PCell DU (e.g., DU 230) and an SCell DU (e.g., DU 230). In some aspects, the PCell DU may be an O-DU (e.g., a PCell O-DU), and the SCell DU may be an O-DU (e.g., an SCell O-DU). The PCell DU may be associated with a PCell configured for a UE, and the SCell DU may be associated with an SCell (or multiple SCells) configured for the UE. That is, the PCell DU may manage the PCell for the UE and communicate with the UE via the PCell, and the SCell UE may manage the SCell (or multiple SCells) for the UE and communicate with the UE via the SCell. The PCell DU and the SCell DU may communicate via an inter-DU interface, such as the D2 interface.

In some aspects, the PCell DU and the SCell DU may have established a D2 connection (e.g., using the D2 connection establishment procedure described above in connection with FIG. 4) and added one or more SCells for the UE (e.g., using the addition or modification procedure described above in connection with FIG. 5) prior to the operations shown in example 800. In some aspects, the operations of example 800 may performed in connection with the UE addition or modification request indicating the first type of inter-DU CA (Option 1 ).

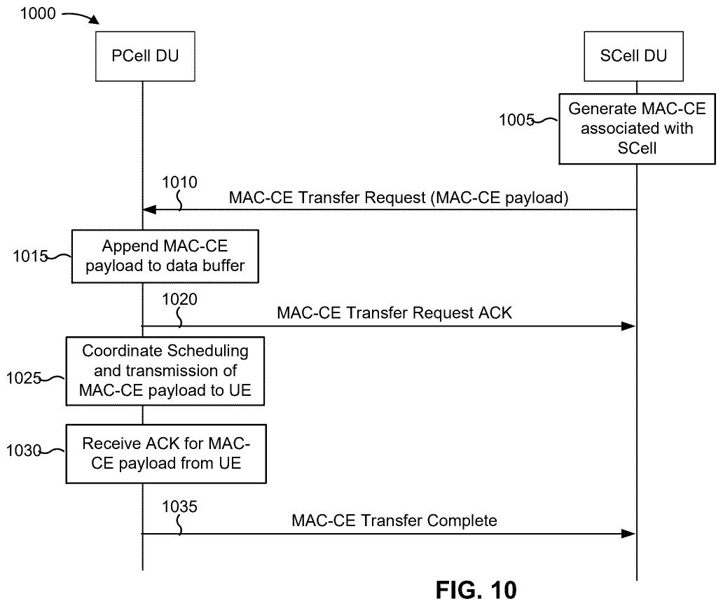

As shown in FIG. 8, and by reference number 805, the PCell DU may receive downlink data for the UE. For example, the PCell DU may receive, from a CU (e.g., from the CU-UP), downlink data (e.g., user data) to be transmitted to the UE. Additionally, or alternatively, the PCell DU may receive, from the SCell DU, a MAC-CE transfer request including a payload of a MAC-CE generated by the SCell DU (e.g., a MAC-CE associated with the SCell), as described in greater detail below in connection with FIG. 10.

As shown by reference number 810, the PCell DU may configure the UE with periodic PUCCH resources for reporting CSI for the SCell. For example, the SCell DU may transmit periodic CSI-RSs on the SCell, and the PCell DU may transmit, to the UE, configuration information that configures the UE to monitor the periodic CSI-RSs transmitted on the SCell and periodically report CSI for the SCell that is based on the measurements of the CSI-RSs transmitted on the SCell. The configuration information may allocate PUCCH resources on the PCell for periodic reporting of the CSI for the SCell. As shown by reference number 815, the PCell DU may receive, from the UE on the PCell, PUCCH transmissions including the CSI for the SCell. For example, the PCell DU may receive periodic PUCCH transmissions including the CSI for the SCell in the periodic PUCCH resources allocated, on the PCell, for reporting the CSI for the SCell. In some examples, the CSI may include one or more of a CQI, a PMI, an RI, an LI, a CRI, an SSBRI, or measurement information, among other examples. As shown by reference number 820, the PCell DU may transmit, and the SCell DU may receive, a UCI transfer message that includes the CSI for the SCell. For example, the UCI transfer message may include one or more of a CQI, a PMI, an RI, an LI, a CRI, an SSBRI, or measurement information, among other examples, for the SCell.

As shown by reference number 825, the PCell DU may calculate the size of a data buffer, for the UE, to be shared with the SCell DU. For example, the PCell DU may calculate the data size that can be scheduled by the SCell DU for transmission to the UE via the SCell based on various factors including the amount of data to be transmitted and current network conditions.

As shown by reference number 830, the PCell DU may transmit, and the SCell DU may receive, a downlink data scheduling request and an indication of a priority for the UE. The downlink data scheduling request is a request for the SCell DU to schedule a downlink data transmission to the UE via the SCell. The downlink data scheduling request may indicate the size of the data (e.g., in bytes) that can be scheduled by the SCell DU for transmission to the UE via the SCell, and a range of slots in which the data transmission to the UE via the SCell is to be scheduled. Accordingly, to facilitate inter-DU CA, the PCell DU shares with the SCell DU, via the data scheduling request, the amount of downlink data (e.g., the data size) that can be scheduled by the SCell DU for transmission to the UE via the SCell and the range of slots in which the transmission of the downlink data to the UE via the SCell is to be scheduled by the SCell DU.

In some examples, the priority for the UE may be a priority value for the UE or a priority range (e.g., between a minimum value and a maximum value) for the UE. In some aspects, the PCell DU may indicate, to the SCell DU, a priority value (or values) per UE, for each UE for which the SCell DU is to request to schedule a downlink transmission on the SCell. The per-UE priority values may be used by the scheduler of the SCell DU during scheduling of downlink data transmissions for UEs managed by the PCell DU. In the case of the first type of inter-DU CA (Option 1 ), the SCell DU may not have RLC-bearer/QoS flow-level visibility to the UEs managed by the PCell DU, and the per-UE priority value provides a coarse priority metric that can be utilized by the SCell DU scheduler. In some aspects, the PCell DU may determine the priority associated with the UE (e.g., the per-UE priority) based on at least one of a UE identifier (ID) associated with the UE, a slice ID associated with the UE, or a QoS indicator for a DRB associated with the UE.

In some aspects, the indication of the priority for the UE (e.g., the per-UE priority) may be included in the downlink data scheduling request. In this case, the downlink data scheduling request may include the size of the data buffer to be shared with the SCell DU, the range of slots, and the indication of the priority for the UE. This enables a dynamic per-UE priority indication. In some aspects, the indication of the priority of the DU may be a semi-static per-UE priority indication included in the UE addition or modification request during the addition or modification procedure. Additionally, or alternatively, the UE addition or modification request may indicate a range of the UE priority values for the UE, and the downlink data scheduling request may indicate a priority value for the UE within the range of priority values for the UE. Additionally, or alternatively, the UE addition or modification request may indicate a default priority value for the UE, and the downlink data scheduling request may indicate a priority value that overrides the default value. In some aspects, during the D2 setup procedure, to establish a connection between the DUs, a first DU (initiator) (e.g., the PCell DU or the SCell DU) may propose the range of per UE priority values and a second O-DU (responder) (e.g., the PCell DU or the SCell DU) may either confirm or modify the range of priority values. In this case, the indication of the priority for the UE may be within the range of priority values.

As shown by reference number 835, the SCell DU may schedule a downlink data transmission to the UE via the SCell in accordance with the downlink data scheduling request and the priority value. For example, the SCell DU scheduler may manage downlink data transmissions for its own UEs with complete flow level information and downlink data transmissions for UEs added by D2 interface based on the per-UE priority values. That is, the SCell DU may use the per-UE priority values for one or more UEs added by the D2 interface determine how to prioritize scheduling of a downlink transmissions via the SCell for the UEs added by the D2 interface relative to each other and relative to downlink transmissions for other UEs managed by the SCell DU. For example, the SCell DU may determine whether to prioritize the downlink transmission for a first UE added by the D2 interface or a second UE managed by the SCell DU based on whether the priority value for the first UE is in an upper portion of the range of priority values and based on the flow level information (e.g., QoS information) associated with the second UE. The SCell DU may determine the actual data size that can be scheduled for transmission to the UE via the SCell. The SCell DU may schedule (e.g., allocate resources on the SCell for) a PDSCH transmission of a certain data size (e.g., up to the data size indicated in the downlink data scheduling request) and with a certain timing (e.g., within the range of slots indicated in the downlink data scheduling request). For example, the SCell DU may compare the data size indicated in the downlink data scheduling request with other scheduling requests, data buffers associated with other UEs managed by the SCell DU, a prioritization of the UE relative other UEs based on the priority value for the UE, and an amount of available resources within the range of slots indicated in the downlink data scheduling request to determine how much data for the SCell DU can actually transmit to the UE via the SCell. The amount of data that the SCell DU can actual transmit to the UE via the SCell may also depend on transmission parameters selected for the transmission of the downlink data. For example, the SCell DU MAC layer may select the time and frequency resources, the MCS, the number of layers, and the precoder for the transmission of the downlink data, and the scheduling grant, determined by the SCell DU MAC layer, may determine the size of a TB to be transmitted to the UE in the scheduled transmission. The SCell DU may also schedule (e.g., allocate resources on the SCell for) an accompanying PDCCH transmission that includes DCI associated with the PDSCH transmission.

As shown by reference number 840, the SCell DU may transmit, and the PCell DU may receive, a downlink data request. The downlink data request is a request for the downlink data to be transmitted to the UE in the scheduled downlink data transmission via the SCell. The downlink data request may indicate the data size of the scheduled downlink data transmission on the SCell (e.g., the TB size, determined by the SCell DU, for the scheduled downlink data transmission via the SCell). The downlink data request may also indicate the scheduled PDCCH slot timing.

As shown by reference number 845, the PCell DU may allocate PUCCH resources associated with the scheduled downlink data transmission on the SCell and generate a TB for the scheduled downlink data transmission on the SCell. The PCell DU may allocate the PUCCH resources and generate the TB based on the downlink data request. The PCell DU may generate the TB based at least in part on the data size of the scheduled downlink data transmission. For example, the PCell may generate a TB of the data size indicated in the downlink data request. The PCell DU may allocate the PUCCH resources associated with the scheduled downlink data transmission on the SCell based at least in part on the PDCCH slot timing indicated in the downlink data request. For example, the PCell DU may allocate PUCCH resources on the PCell for transmission, by the UE, of HARQ feedback associated with the scheduled PDSCH transmission on the SCell.

As shown by reference number 850, the PCell DU may transmit, and the SCell DU may receive, PUCCH resource information associated with the PUCCH resources allocated by the PCell DU. For example, the PUCCH resource information may indicate a K1 value (e.g., a PDSCH-to-ACK/NACK timing offset) and a DAI associated with the allocated PUSCH resources.

As shown by reference number 855, the PCell DU may transmit, and the SCell DU may receive, a downlink data response. The downlink data response may include the TB to be transmitted to the UE in the scheduled downlink data (e.g., PDSCH) transmission on the SCell.

As shown by reference number 860, the SCell DU may transmit the scheduled downlink transmissions, including the PDSCH transmission and the accompanying PDCCH transmission, to the UE via the SCell. The PDCCH transmission may include the PUCCH resource information (e.g., the K1 value and the DAI) received from the PCell DU. The PDSCH transmission may include the TB (e.g., including the user data) received from the PCell DU in the downlink data response.

As shown by reference number 865, the PCell DU may receive, from the UE on the PCell, a PUCCH transmission including a HARQ ACK associated with the downlink data transmission (e.g., the PDSCH transmission) on the SCell. The UE may transmit HARQ feedback (e.g., HARQ ACK/NACK feedback) associated with the downlink data transmission via the allocated PUCCH resources indicated by the PUCCH resource information included in the PDCCH transmission. For example, the UE may transmit a HARQ ACK in connection with successfully receiving and decoding the downlink data transmission. The PCell DU may receive the PUCCH transmission including the HARQ feedback in the allocated PUCCH resources on the PCell that are indicated in the PDCCH transmission transmitted by the SCell DU via the SCell.

As shown by reference number 870, the PCell DU may transmit, and the SCell DU may receive, a UCI transfer message that includes the HARQ feedback (e.g., the HARQ ACK) associated with the downlink data transmission via the SCell. As shown by reference number 875, the SCell DU may transmit, and the PCell DU may receive, a downlink data status message that indicates a status of the downlink data transmission via the SCell. For example, the SCell DU may transmit, to the PCell DU, a downlink data status message indicating success in connection with receiving the UCI transfer message including the HARQ ACK.

As indicated above, FIG. 8 is provided as an example. Other examples may differ from what is described with respect to FIG. 8.

FIG. 9 is a diagram illustrating an example 900 associated with priority handling for SCell DU driven scheduling in inter-DU CA. As shown in FIG. 9, example 900 includes communication between a PCell DU (e.g., DU 230) and an SCell DU (e.g., DU 230). In some aspects, the PCell DU may be an O-DU (e.g., a PCell O-DU), and the SCell DU may be an O-DU (e.g., an SCell O-DU). The PCell DU may be associated with a PCell configured for a UE, and the SCell DU may be associated with an SCell (or multiple SCells) configured for the UE. That is, the PCell DU may manage the PCell for the UE and communicate with the UE via the PCell, and the SCell UE may manage the SCell (or multiple SCells) for the UE and communicate with the UE vial the SCell. The PCell DU and the SCell DU may communicate via an inter-DU interface, such as the D2 interface.

In some aspects, the PCell DU and the SCell DU may have established a D2 connection (e.g., using the D2 connection establishment procedure described above in connection with FIG. 4) and added one or more SCells for the UE (e.g., using the addition or modification procedure described above in connection with FIG. 5) prior to the operations shown in example 900. In some aspects, the operations of example 900 may performed in connection with the UE addition or modification request indicating the second type of inter-DU CA (Option 2 ).

As shown in FIG. 9, and by reference number 905, the PCell DU may receive downlink data for the UE. For example, the PCell DU may receive, from a CU (e.g., from the CU-UP), downlink data (e.g., user data) to be transmitted to the UE.

Additionally, or alternatively, the PCell DU may receive, from the SCell DU, a MAC-CE transfer request including a payload of a MAC-CE generated by the SCell DU (e.g., a MAC-CE associated with the SCell), as described in greater detail below in connection with FIG. 10.

As shown by reference number 910, the PCell DU may configure the UE with periodic PUCCH resources for reporting CSI for the SCell. For example, the SCell DU may transmit periodic CSI-RSs on the SCell, and the PCell DU may transmit, to the UE, configuration information that configures the UE to monitor the periodic CSI-RSs transmitted on the SCell and periodically report CSI for the SCell that is based on the measurements of the CSI-RSs transmitted on the SCell. The configuration information may allocate PUCCH resources on the PCell for periodic reporting of the CSI for the SCell. As shown by reference number 915, the PCell DU may receive, from the UE on the PCell, PUCCH transmissions including the CSI for the SCell. For example, the PCell DU may receive periodic PUCCH transmissions including the CSI for the SCell in the periodic PUCCH resources allocated, on the PCell, for reporting the CSI for the SCell. In some examples, the CSI may include one or more of a CQI, a PMI, an RI, an LI, a CRI, an SSBRI, or measurement information, among other examples. As shown by reference number 920, the PCell DU may transmit, and the SCell DU may receive, a UCI transfer message that includes the CSI for the SCell. For example, the UCI transfer message may include one or more of a CQI, a PMI, an RI, an LI, a CRI, an SSBRI, or measurement information, among other examples, for the SCell.

As shown by reference number 925, the PCell DU may calculate the size of a data buffer, for the UE, to be shared with the SCell DU. For example, the PCell DU may calculate the data size that can be scheduled by the SCell DU for transmission to the UE via the SCell based on various factors including the amount of data to be transmitted and current network conditions.

As shown by reference number 930, the PCell DU may transmit, and the SCell DU may receive, a downlink data scheduling request. The downlink data scheduling request is a request for the SCell DU to schedule a downlink data transmission to the UE via the SCell. The downlink data scheduling request may indicate RLC buffer states for the UE, and a range of slots in which a data transmission to the UE via the SCell is to be scheduled. The RLC buffer states may include a buffer size (e.g., buffer status) for each RLC bearer expected to be scheduled by the SCell DU for the UE.

As shown by reference number 935, the SCell DU may schedule a downlink data transmission to the UE via the SCell in accordance with the downlink data scheduling request. The SCell DU may schedule (e.g., allocate resources on the SCell for) a PDSCH transmission of a certain data size (e.g., up to the data size indicated in the downlink data request) and with a certain timing (e.g., within the range of slots indicated in the downlink data scheduling request). The SCell DU may also schedule (e.g., allocate resources on the SCell for) an accompanying PDCCH transmission that includes DCI associated with the PDSCH transmission. The SCell may also determine a multiplexing instruction (e.g., how many bits per LCID or RLC bearer are to be packed in the TB) based on the buffer status for each RLC bearer expected to be scheduled by the SCell DU for the UE.

As shown by reference number 940, the SCell DU may transmit, and the PCell DU may receive, a downlink data request. The downlink data request is a request for the downlink data to be transmitted to the UE in the scheduled downlink data transmission via the SCell. The downlink data request may indicate the data size of the scheduled downlink data transmission on the SCell (e.g., the actual data size that can be transmitted via the SCell). The downlink data request may also indicate the scheduled PDCCH slot timing. In some aspects, the downlink data request may also indicate a multiplexing instruction (e.g., a number of bits per LCID to be included in the TB).

As shown by reference number 945, the PCell DU may allocate PUCCH resources associated with the scheduled downlink data transmission on the SCell and generate a TB for the scheduled downlink data transmission on the SCell. The PCell DU may allocate the PUCCH resources and generate the TB based on the downlink data request. The PCell DU may generate the TB based at least in part on the data size indicated in the downlink data request and based at least in part on the multiplexing instruction indicated in the downlink data request. For example, the PCell DU may perform the multiplexing of the TB based at least in part on the requested number of bits per LCID indicated in the downlink data request. The PCell DU may allocate the PUCCH resources associated with the scheduled downlink data transmission on the SCell based at least in part on the PDCCH slot timing indicated in the downlink data request. For example, the PCell DU may allocate PUCCH resources on the PCell for transmission, by the UE, of HARQ feedback associated with the scheduled PDSCH transmission on the SCell.

As shown by reference number 950, the PCell DU may transmit, and the SCell DU may receive, PUCCH resource information associated with the PUCCH resources allocated by the PCell DU. For example, the PUCCH resource information may indicate a K1 value (e.g., a PDSCH-to-ACK/NACK timing offset) and a DAI associated with the allocated PUSCH resources.

As shown by reference number 955, the PCell DU may transmit, and the SCell DU may receive, a downlink data response. The downlink data response may include the TB to be transmitted to the UE in the scheduled downlink data (e.g., PDSCH) transmission on the SCell.

As shown by reference number 960, the SCell DU may transmit the scheduled downlink transmissions, including the PDSCH transmission and the accompanying PDCCH transmission, to the UE via the SCell. The PDCCH transmission may include the PUCCH resource information (e.g., the K1 value and the DAI) received from the PCell DU. The PDSCH transmission may include the TB (e.g., including the user data) received from the PCell DU in the downlink data response.

As shown by reference number 965, the PCell DU may receive, from the UE on the PCell, a PUCCH transmission including a HARQ ACK associated with the downlink data transmission (e.g., the PDSCH transmission) on the SCell. The UE may transmit HARQ feedback (e.g., HARQ ACK/NACK feedback) associated with the downlink data transmission via the allocated PUCCH resources indicated by the PUCCH resource information included in the PDCCH transmission. For example, the UE may transmit a HARQ ACK in connection with successfully receiving and decoding the downlink data transmission. The PCell DU may receive the PUCCH transmission including the HARQ feedback in the allocated PUCCH resources on the PCell that are indicated in the PDCCH transmission transmitted by the SCell DU via the SCell.

As shown by reference number 970, the PCell DU may transmit, and the SCell DU may receive, a UCI transfer message that includes the HARQ feedback (e.g., the HARQ ACK) associated with the downlink data transmission via the SCell. As shown by reference number 975, the SCell DU may transmit, and the PCell DU may receive, a downlink data status message that indicates a status of the downlink data transmission via the SCell. For example, the SCell DU may transmit, to the PCell DU, a downlink data status message indicating success in connection with receiving the UCI transfer message including the HARQ ACK.

As indicated above, FIG. 9 is provided as an example. Other examples may differ from what is described with respect to FIG. 9.

FIG. 10 is a diagram illustrating an example 1000 associated with MAC-CE transfer in inter-DU CA. As shown in FIG. 10, example 1000 includes communication between a PCell DU (e.g., DU 230) and an SCell DU (e.g., DU 230). In some aspects, the PCell DU may be an O-DU (e.g., a PCell O-DU), and the SCell DU may be an O-DU (e.g., an SCell O-DU). The PCell DU may be associated with a PCell configured for a UE, and the SCell DU may be associated with an SCell (or multiple SCells) configured for the UE. That is, the PCell DU may manage the PCell for the UE and communicate with the UE via the PCell, and the SCell UE may manage the SCell (or multiple SCells) for the UE and communicate with the UE vial the SCell. The PCell DU and the SCell DU may communicate via an inter-DU interface, such as the D2 interface.

As shown in FIG. 10, and by reference number 1005, the SCell DU may generate a MAC-CE associated with the SCell for a UE. For example, the SCell DU may generate a MAC-CE that applies to the SCell for the UE. In the case of the first type of inter-DU CA (Option 1 ), the transmission of this MAC-CE to the UE may not be directly scheduled by the SCell DU.

As shown by reference number 1010, the SCell DU may transmit, and the PCell DU may receive, a MAC-CE transfer request that includes the payload of the MAC-CE generated by the SCell DU. In some aspects, the MAC-CE transfer request may be included in a downlink data request, for example as an optional field.

As shown by reference number 1015, the PCell DU may append the MAC-CE payload included in the MAC-CE transfer request to a data buffer associated with the UE. For example, the PCell DU may create a new logical channel for the MAC-CE payload generated by the SCell DU, and add the MAC-CE payload to a data buffer for that logical channel. The PCell DU may obtain the LCID for the logical channel from the MAC-CE payload.

As shown by reference number 1020, the PCell DU may transmit, and the SCell DU may receive, a MAC-CE transfer request ACK in connection with receiving the MAC-CE transfer request. For example, the MAC-CE transfer request ACK may be an acknowledgment of reception, by the PCell DU, of the MAC-CE transfer request.

As shown by reference number 1025, the PCell DU may coordinate scheduling and transmission of the MAC-CE payload to the UE in connection with appending the

MAC-CE payload to the data buffer associated with the UE. In some aspects, the PCell DU may schedule a data transmission, including the MAC-CE payload, on the PCell. In this case, the PCell DU may transmit a downlink data transmission (e.g., a PDSCH transmission) including the MAC-CE payload to the UE via the PCell. In some other aspects, the PCell DU may cause the MAC-CE payload to be transmitted via the SCell by the SCell DU (or via another SCell by another SCell DU). For example, the PCell DU may transmit, to the SCell DU, a downlink data scheduling request for scheduling transmission of downlink data to the UE via the SCell; receive, from the SCell DU, a downlink data request associated with a scheduled downlink data transmission to the UE via the SCell; and transmit, to the SCell DU, a TB that includes the MAC-CE payload to be transmitted in the scheduled downlink data transmission to the UE via the SCell. In this case, the SCell DU may transmit the TB, including the MAC-CE payload, to the UE via the SCell.

As shown by reference number 1030, the PCell DU may receive, from the UE, an ACK (e.g., a HARQ ACK) associated with the MAC-CE payload. For example, the UE may transmit, to the PCell DU via the PCell, a PUCCH transmission including HARQ feedback associated with the MAC-CE payload. The HARQ feedback associated with the MAC-CE payload may be HARQ feedback for the TB that includes the MAC-CE payload (e.g., the TB including the MAC protocol (PDU) carrying the MAC-CE). The UE may transmit a HARQ ACK indicative of successful reception and decoding of the TB including the MAC-CE payload by the UE. The PCell DU may receive the PUCCH transmission from the UE via the PCell regardless of whether the MAC-CE payload is transmitted via the PCell (e.g., by the PCell DU) or the SCell (e.g., by the SCell DU).

As shown by reference number 1035, the PCell DU may transmit, and the SCell DU may receive, a MAC-CE transfer complete message. The PCell DU may transmit the MAC-CE transfer complete message to the SCell DU in connection with receiving the ACK for the TB including the MAC-CE payload (e.g., the TB including the MAC PDU carrying the MAC-CE) from the UE. For example, once the PCell DU MAC layer receives the ACK for the TB including the MAC-CE from the lower layer, the PCell DU MAC layer may clear the buffer of the corresponding logical channel and transmit the MAC-CE transfer complete message to the SCell DU to indicate that the UE has successfully received and decoded the MAC-CE payload.

As indicated above, FIG. 10 is provided as an example. Other examples may differ from what is described with respect to FIG. 10.

FIG. 11 is a diagram illustrating an example process 1100 performed, for example, at a first DU or an apparatus of a first DU. Example process 1100 is an example where the apparatus or the first DU (e.g., DU 230, network node 110, PCell DU) performs operations associated with priority handling in inter-DU CA.

As shown in FIG. 11, in some aspects, process 1100 may include transmitting, to a second DU, a data scheduling request for scheduling transmission of data from the second DU to a UE via an SCell for the UE, and an indication of a priority associated with the UE (block 1110). For example, the first DU (e.g., using transmission component 1504 or communication manager 1506, depicted in FIG. 15) may transmit, to a second DU, a data scheduling request for scheduling transmission of data from the second DU to a UE via an SCell for the UE, and an indication of a priority associated with the UE, as described above in connection with reference number 830 of FIG. 8.

As further shown in FIG. 11, in some aspects, process 1100 may include receiving, from the second DU, a data request associated with a data transmission from the second DU to the UE via the SCell scheduled in accordance with the data scheduling request and the priority associated with the UE (block 1120). For example, the first DU (e.g., using reception component 1502 or communication manager 1506, depicted in FIG. 15) may receive, from the second DU, a data request associated with a data transmission from the second DU to the UE via the SCell scheduled in accordance with the data scheduling request and the priority associated with the UE, as described above in connection with reference number 840 of FIG. 8.

As further shown in FIG. 11, in some aspects, process 1100 may include transmitting, to the second DU, a data response including a transport block for the data transmission from the second DU to the UE via the SCell (block 1130). For example, the first DU (e.g., using transmission component 1504 or communication manager 1506, depicted in FIG. 15) may transmit, to the second DU, a data response including a transport block for the data transmission from the second DU to the UE via the SCell, as described above in connection with reference number 855 of FIG. 8.

Process 1100 may include additional aspects, such as any single aspect or any combination of aspects described below or in connection with one or more other processes described elsewhere herein.

In a first aspect, the first DU is associated with a PCell for the UE, and the second DU is associated with the SCell for the UE.

In a second aspect, alone or in combination with the first aspect, the indication of the priority associated with the UE indicates a priority value associated with the UE.

In a third aspect, alone or in combination with one or more of the first and second aspects, the indication of the priority associated with the UE indicates a range of priority values associated with the UE.

In a fourth aspect, alone or in combination with one or more of the first through third aspects, the indication of the priority associated with the UE is included in the data scheduling request.

In a fifth aspect, alone or in combination with one or more of the first through fourth aspects, the indication of the priority associated with the UE is transmitted via a D2 interface between the first DU and the second DU.

In a sixth aspect, alone or in combination with one or more of the first through fifth aspects, process 1100 includes communicating, with the second DU, a range of priority values during a setup procedure for establishing a connection via an interface between the first DU and the second DU, wherein the priority associated with the UE is within the range of priority values.

In a seventh aspect, alone or in combination with one or more of the first through sixth aspects, transmitting the indication of the priority associated with the UE includes transmitting the indication of the priority associated with the UE to the second DU in a UE addition request or UE modification request associated with the UE.

In an eighth aspect, alone or in combination with one or more of the first through seventh aspects, process 1100 includes transmitting, to the second DU in a UE addition request or UE modification request associated with the UE, an indication of a range of priority values associated with the UE, wherein the indication of the priority of the UE is included within the data scheduling request and indicates a priority value within the range of priority values associated with the UE.

In a ninth aspect, alone or in combination with one or more of the first through eighth aspects, transmitting the indication of the priority associated with the UE includes transmitting, to the second DU in a UE addition request or UE modification request associated with the UE, an indication of a first priority value associated with the UE, and transmitting, to the second DU in the data scheduling request, an indication of a second priority value associated with the UE, wherein the first priority value is a default priority value associated with the UE, and wherein the second priority value overrides the default priority value for the data scheduling request.

In a tenth aspect, alone or in combination with one or more of the first through ninth aspects, transmitting the indication of the priority associated with the UE includes transmitting, to the second DU, indications of per-UE priority values for a plurality of UEs including the UE.

In an eleventh aspect, alone or in combination with one or more of the first through tenth aspects, process 1100 includes determining the priority associated with the UE based on at least one of a UE ID associated with the UE, a slice ID associated with the UE, or a QoS indicator for a DRB associated with the UE.

In a twelfth aspect, alone or in combination with one or more of the first through eleventh aspects, process 1100 includes transmitting, to the second DU, a UE addition request or UE modification request associated with the UE, wherein the UE addition request or UE modification request indicates a first type of inter-DU carrier aggregation associated with PCell DU driven scheduling or a second type of inter-DU carrier aggregation associated with SCell DU driven scheduling.

In a thirteenth aspect, alone or in combination with one or more of the first through twelfth aspects, transmitting the priority associated with the UE is based at least in part on the UE addition request or UE modification request indicating the first type of inter-DU carrier aggregation.

In a fourteenth aspect, alone or in combination with one or more of the first through thirteenth aspects, the UE addition request or UE modification request indicates the second type of inter-DU carrier aggregation by including DRB information, or the UE addition request or UE modification request indicates the first type of inter-DU carrier aggregation by not including the DRB information.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, at a first DU or an apparatus of a first DU. Example process 1200 is an example where the apparatus or the first DU (e.g., DU 230, network node 110, SCell DU) performs operations associated with priority handling in inter-DU CA.

As shown in FIG. 12, in some aspects, process 1200 may include receiving, from a second DU, a data scheduling request for scheduling transmission of data from the first DU to a UE via an SCell for the UE, and an indication of a priority associated with the UE (block 1210). For example, the first DU (e.g., using reception component 1502 or communication manager 1506, depicted in FIG. 15) may receive, from a second DU, a data scheduling request for scheduling transmission of data from the first DU to a UE via an SCell for the UE, and an indication of a priority associated with the UE, as described above in connection with reference number 830 of FIG. 8.

As further shown in FIG. 12, in some aspects, process 1200 may include scheduling a data transmission to the UE via the SCell in accordance with the data scheduling request and the priority associated with the UE (block 1220). For example, the first DU (e.g., using communication manager 1506, depicted in FIG. 15) may schedule a data transmission to the UE via the SCell in accordance with the data scheduling request and the priority associated with the UE, as described above in connection with reference number 835 of FIG. 8.

As further shown in FIG. 12, in some aspects, process 1200 may include transmitting, to the second DU, a data request associated with the data transmission to the UE via the SCell (block 1230). For example, the first DU (e.g., using transmission component 1504 or communication manager 1506, depicted in FIG. 15) may transmit, to the second DU, a data request associated with the data transmission to the UE via the SCell, as described above in connection with reference number 840 of FIG. 8.

As further shown in FIG. 12, in some aspects, process 1200 may include receiving, from the second DU, a data response including a transport block for the data transmission to the UE via the SCell (block 1240). For example, the first DU (e.g., using reception component 1502 or communication manager 1506, depicted in FIG. 15) may receive, from the second DU, a data response including a transport block for the data transmission to the UE via the SCell, as described above in connection with reference number 855 of FIG. 8.

Process 1200 may include additional aspects, such as any single aspect or any combination of aspects described below or in connection with one or more other processes described elsewhere herein.

In a first aspect, process 1200 includes transmitting, to the UE via the SCell, the data transmission including the transport block.

In a second aspect, alone or in combination with the first aspect, the second DU is associated with a PCell for the UE, and the first DU is associated with the SCell for the UE.

In a third aspect, alone or in combination with one or more of the first and second aspects, the indication of the priority associated with the UE indicates a priority value associated with the UE.

In a fourth aspect, alone or in combination with one or more of the first through third aspects, the indication of the priority associated with the UE indicates a range of priority values associated with the UE.

In a fifth aspect, alone or in combination with one or more of the first through fourth aspects, the indication of the priority associated with the UE is included in the data scheduling request.

In a sixth aspect, alone or in combination with one or more of the first through fifth aspects, the indication of the priority associated with the UE is received via a D2 interface between the first DU and the second DU.

In a seventh aspect, alone or in combination with one or more of the first through sixth aspects, process 1200 includes communicating, with the second DU, a range of priority values during a setup procedure for establishing a connection via an interface between the first DU and the second DU, wherein the priority associated with the UE is within the range of priority values.

In an eighth aspect, alone or in combination with one or more of the first through seventh aspects, receiving the indication of the priority associated with the UE includes receiving the indication of the priority associated with the UE from the second DU in a UE addition request or UE modification request associated with the UE.

In a ninth aspect, alone or in combination with one or more of the first through eighth aspects, process 1200 includes receiving, from the second DU in a UE addition request or UE modification request associated with the UE, an indication of a range of priority values associated with the UE, wherein the indication of the priority of the UE is included within the data scheduling request and indicates a priority value within the range of priority values associated with the UE.

In a tenth aspect, alone or in combination with one or more of the first through ninth aspects, receiving the indication of the priority associated with the UE includes receiving, from the second DU in a UE addition request or UE modification request associated with the UE, an indication of a first priority value associated with the UE, and receiving, from the second DU in the data scheduling request, an indication of a second priority value associated with the UE, wherein the first priority value is a default priority value associated with the UE, and wherein the second priority value overrides the default priority value for the data scheduling request.

In an eleventh aspect, alone or in combination with one or more of the first through tenth aspects, receiving the indication of the priority associated with the UE includes receiving, from the second DU, indications of per-UE priority values for a plurality of UEs including the UE.

In a twelfth aspect, alone or in combination with one or more of the first through eleventh aspects, process 1200 includes receiving, from the second DU, a UE addition request or UE modification request associated with the UE, wherein the UE addition request or UE modification request indicates a first type of inter-DU carrier aggregation associated with PCell DU driven scheduling or a second type of inter-DU carrier aggregation associated with SCell DU driven scheduling.

In a thirteenth aspect, alone or in combination with one or more of the first through twelfth aspects, receiving the priority associated with the UE is based at least in part on the UE addition request or UE modification request indicating the first type of inter-DU carrier aggregation.

In a fourteenth aspect, alone or in combination with one or more of the first through thirteenth aspects, the UE addition request or UE modification request indicates the second type of inter-DU carrier aggregation by including DRB information, or the UE addition request or UE modification request indicates the first type of inter-DU carrier aggregation by not including the DRB information.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, at a first DU or an apparatus of a first DU. Example process 1300 is an example where the apparatus or the first DU (e.g., DU 230, network node 110, PCell DU) performs operations associated with MAC-CE transfer in inter-DU CA.

As shown in FIG. 13, in some aspects, process 1300 may include receiving, from a second DU, a MAC-CE transfer request including a MAC-CE payload associated with an SCell for a UE (block 1310). For example, the first DU (e.g., using reception component 1502 or communication manager 1506, depicted in FIG. 15) may receive, from a second DU, a MAC-CE transfer request including a MAC-CE payload associated with an SCell for a UE, as described above in connection with reference number 1010 of FIG. 10.

As further shown in FIG. 13, in some aspects, process 1300 may include appending the MAC-CE payload to a data buffer associated with the UE (block 1320). For example, the first DU (e.g., using communication manager 1506, depicted in FIG. 15) may append the MAC-CE payload to a data buffer associated with the UE, as described above in connection with reference number 1015 of FIG. 10.

As further shown in FIG. 13, in some aspects, process 1300 may include coordinating scheduling and transmission of the MAC-CE payload to the UE based on the data buffer associated with the UE (block 1330). For example, the DU (e.g., using communication manager 1506, depicted in FIG. 15) may coordinate scheduling and transmission of the MAC-CE payload to the UE based on the data buffer associated with the UE, as described above in connection with reference number 1025 of FIG. 10.

Process 1300 may include additional aspects, such as any single aspect or any combination of aspects described below or in connection with one or more other processes described elsewhere herein.

In a first aspect, the first DU is associated with a PCell for the UE, and the second DU is associated with the SCell for the UE.

In a second aspect, alone or in combination with the first aspect, process 1300 includes transmitting, to the second DU, a MAC-CE transfer request acknowledgement in connection with receiving the MAC-CE transfer request.

In a third aspect, alone or in combination with one or more of the first and second aspects, process 1300 includes receiving, from the UE, an acknowledgment associated with the MAC-CE payload, and transmitting, to the second DU, a MAC-CE transfer complete message in connection with receiving the acknowledgement.

In a fourth aspect, alone or in combination with one or more of the first through third aspects, the MAC-CE transfer request is included in a downlink data request.

In a fifth aspect, alone or in combination with one or more of the first through fourth aspects, the MAC-CE payload is generated by the second DU.

In a sixth aspect, alone or in combination with one or more of the first through fifth aspects, the MAC-CE transfer request is received via a D2 interface between the first DU and the second DU.

In a seventh aspect, alone or in combination with one or more of the first through sixth aspects, coordinating the scheduling and the transmission of the MAC-CE payload to the UE includes scheduling a transmission of downlink data including the MAC-CE payload via a PCell for the UE, and transmitting, to the UE, the downlink data including the MAC-CE payload via the PCell.

In an eighth aspect, alone or in combination with one or more of the first through seventh aspects, coordinating the scheduling and the transmission of the MAC-CE payload to the UE includes transmitting, to the second DU, a downlink data scheduling request for scheduling transmission of downlink data to the UE via the SCell; receiving, from the second DU, a downlink data request associated with a scheduled downlink data transmission to the UE via the SCell; and transmitting, to the second DU, a transport block for the scheduled downlink data transmission to the UE via the SCell, wherein the transport block includes the MAC-CE payload.

In a ninth aspect, alone or in combination with one or more of the first through eighth aspects, process 1300 includes transmitting, to the second DU, an indication of priority, associated with the UE, for scheduling transmission of downlink data to the UE via the SCell.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, at a first DU or an apparatus of a first DU. Example process 1400 is an example where the apparatus or the first DU (e.g., DU 230, network node 110, SCell DU) performs operations associated with MAC-CE transfer in inter-DU CA.

As shown in FIG. 14, in some aspects, process 1400 may include generating a MAC-CE associated with an SCell for a UE (block 1410). For example, the first DU (e.g., using communication manager 1506, depicted in FIG. 15) may generate a MAC-CE associated with an SCell for a UE, as described above in connection with reference number 1005 of FIG. 10.

As further shown in FIG. 14, in some aspects, process 1400 may include transmitting, to a second DU, a MAC-CE transfer request including a payload of the MAC-CE (block 1420). For example, the first DU (e.g., using transmission component 1504 or communication manager 1506, depicted in FIG. 15) may transmit, to a second DU, a MAC-CE transfer request including a payload of the MAC-CE, as described above in connection with reference number 1010 of FIG. 10.

Process 1400 may include additional aspects, such as any single aspect or any combination of aspects described below or in connection with one or more other processes described elsewhere herein.

In a first aspect, the second DU is associated with a PCell for the UE, and the first DU is associated with the SCell for the UE.

In a second aspect, alone or in combination with the first aspect, process 1400 includes receiving, from the second DU, a MAC-CE transfer request acknowledgement associated with the MAC-CE transfer request.

In a third aspect, alone or in combination with one or more of the first and second aspects, process 1400 includes receiving, from the second DU, a MAC-CE transfer complete message associated with an acknowledgement of reception of the payload of the MAC-CE by the UE.

In a fourth aspect, alone or in combination with one or more of the first through third aspects, the MAC-CE transfer request is included in a downlink data request.

In a fifth aspect, alone or in combination with one or more of the first through fourth aspects, the MAC-CE transfer request is transmitted via a D2 interface between the first DU and the second DU.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram of an example apparatus 1500 for wireless communication. The apparatus 1500 may be a DU, or a DU may include the apparatus 1500. In some aspects, the apparatus 1500 includes a reception component 1502, a transmission component 1504, or a communication manager 1506, which may be in communication with one another (for example, via one or more buses or one or more other components). In some aspects, the communication manager 1506 is the communication manager 155 described in connection with FIG. 1. As shown, the apparatus 1500 may communicate with another apparatus 1508, such as a UE or a network node (such as a CU, a DU, an RU, or a base station), using the reception component 1502 and the transmission component 1504. The communication manager 1506 may be included in, or implemented via, a processing system (for example, the processing system 145 described in connection with FIG. 1) of the DU.

In some aspects, the apparatus 1500 may be configured to perform one or more operations described herein in connection with FIGS. 3-10. Additionally, or alternatively, the apparatus 1500 may be configured to perform one or more processes described herein, such as process 1100 of FIG. 11, process 1200 of FIG. 12, process 1300 of FIG. 13, process 1400 of FIG. 14, or a combination thereof. In some aspects, the apparatus 1500 or one or more components shown in FIG. 15 may include one or more components of the network node described in connection with FIG. 1. Additionally, or alternatively, one or more components shown in FIG. 15 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1502 may receive communications, such as reference signals, control information, data communications, or a combination thereof, from the apparatus 1508. The reception component 1502 may provide received communications to one or more other components of the apparatus 1500. In some aspects, the reception component 1502 may perform signal processing on the received communications, and may provide the processed signals to the one or more other components of the apparatus 1500. In some aspects, the reception component 1502 may include one or more components of the network node described above in connection with FIG. 1, such as a radio, one or more RF chains, one or more transceivers, or one or more modems, each of which may in turn be coupled with one or more antennas of the network node.

The transmission component 1504 may transmit communications, such as reference signals, control information, data communications, or a combination thereof, to the apparatus 1508. In some aspects, one or more other components of the apparatus 1500 may generate communications and may provide the generated communications to the transmission component 1504 for transmission to the apparatus 1508. In some aspects, the transmission component 1504 may perform signal processing on the generated communications, and may transmit the processed signals to the apparatus 1508. In some aspects, the transmission component 1504 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1504 may be co-located with the reception component 1502.

The communication manager 1506 may support operations of the reception component 1502 or the transmission component 1504. For example, the communication manager 1506 may receive information associated with configuring reception of communications by the reception component 1502 or transmission of communications by the transmission component 1504. Additionally, or alternatively, the communication manager 1506 may generate or provide control information to the reception component 1502 or the transmission component 1504 to control reception or transmission of communications.

In some aspects, the transmission component 1504 may transmit, to a second DU, a data scheduling request for scheduling transmission of data from the second DU to a UE via an SCell for the UE, and an indication of a priority associated with the UE. The reception component 1502 may receive, from the second DU, a data request associated with a data transmission from the second DU to the UE via the SCell scheduled in accordance with the data scheduling request and the priority associated with the UE. The transmission component 1504 may transmit, to the second DU, a data response including a transport block for the data transmission from the second DU to the UE via the SCell.

The communication manager 1506 may communicate, with the second DU, a range of priority values during a setup procedure for establishing a connection via an interface between the first DU and the second DU, wherein the priority associated with the UE is within the range of priority values.

The transmission component 1504 may transmit, to the second DU in a UE addition request or UE modification request associated with the UE, an indication of a range of priority values associated with the UE, wherein the indication of the priority of the UE is included within the data scheduling request and indicates a priority value within the range of priority values associated with the UE.

The communication manager 1506 may determine the priority associated with the UE based on at least one of a UE ID associated with the UE, a slice ID associated with the UE, or a QoS indicator for a DRB associated with the UE.

The transmission component 1504 may transmit, to the second DU, a UE addition request or UE modification request associated with the UE, wherein the UE addition request or UE modification request indicates a first type of inter-DU carrier aggregation associated with PCell DU driven scheduling or a second type of inter-DU carrier aggregation associated with SCell DU driven scheduling.

In some aspects, the reception component 1502 may receive, from a second DU, a data scheduling request for scheduling transmission of data to a UE via an SCell for the UE, and an indication of a priority associated with the UE. The communication manager 1506 may schedule a data transmission to the UE via the SCell in accordance with the data scheduling request and the priority associated with the UE. The transmission component 1504 may transmit, to the second DU, a data request associated with the data transmission to the UE via the SCell. The reception component 1502 may receive, from the second DU, a data response including a transport block for the data transmission to the UE via the SCell.

The transmission component 1504 may transmit, to the UE via the SCell, the data transmission including the transport block.

The communication manager 1506 may communicate, with the second DU, a range of priority values during a setup procedure for establishing a connection via an interface between the first DU and the second DU, wherein the priority associated with the UE is within the range of priority values.

The reception component 1502 may receive, from the second DU in a UE addition request or UE modification request associated with the UE, an indication of a range of priority values associated with the UE, wherein the indication of the priority of the UE is included within the data scheduling request and indicates a priority value within the range of priority values associated with the UE.

The reception component 1502 may receive, from the second DU, a UE addition request or UE modification request associated with the UE, wherein the UE addition request or UE modification request indicates a first type of inter-DU carrier aggregation associated with PCell DU driven scheduling or a second type of inter-DU carrier aggregation associated with SCell DU driven scheduling.

In some aspects, the reception component 1502 may receive, from a second DU, a MAC-CE transfer request including a MAC-CE payload associated with an SCell for a UE. The communication manager 1506 may append the MAC-CE payload to a data buffer associated with the UE. The communication manager 1506 may coordinate scheduling and transmission of the MAC-CE payload to the UE based on the data buffer associated with the UE.

The transmission component 1504 may transmit, to the second DU, a MAC-CE transfer request acknowledgement in connection with receiving the MAC-CE transfer request.

The reception component 1502 may receive, from the UE, an acknowledgment associated with the MAC-CE payload.

The transmission component 1504 may transmit, to the second DU, a MAC-CE transfer complete message in connection with receiving the acknowledgement.

The transmission component 1504 may transmit, to the second DU, an indication of priority, associated with the UE, for scheduling transmission of downlink data to the UE via the SCell.

In some aspects, the communication manager 1506 may generate a MAC-CE associated with an SCell for a UE. The transmission component 1504 may transmit, to a second DU, a MAC-CE transfer request including a payload of the MAC-CE.

The reception component 1502 may receive, from the second DU, a MAC-CE transfer request acknowledgement associated with the MAC-CE transfer request.

The reception component 1502 may receive, from the second DU, a MAC-CE transfer complete message associated with an acknowledgement of reception of the payload of the MAC-CE by the UE.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

The following provides an overview of some Aspects of the present disclosure:
Aspect 1: A method for wireless communication performed by a first distributed unit (DU), comprising: transmitting, to a second DU, a data scheduling request for scheduling transmission of data from the second DU to a user equipment (UE) via a secondary cell (SCell) for the UE, and an indication of a priority associated with the UE; receiving, from the second DU, a data request associated with a data transmission from the second DU to the UE via the SCell scheduled in accordance with the data scheduling request and the priority associated with the UE; and transmitting, to the second DU, a data response including a transport block for the data transmission from the second DU to the UE via the SCell.
Aspect 2: The method of Aspect 1, wherein the first DU is associated with a primary cell (PCell) for the UE, and wherein the second DU is associated with the SCell for the UE.
Aspect 3: The method of any of Aspects 1-2, wherein the indication of the priority associated with the UE indicates a priority value associated with the UE.
Aspect 4: The method of any of Aspects 1-3, wherein the indication of the priority associated with the UE indicates a range of priority values associated with the UE.
Aspect 5: The method of any of Aspects 1-4, wherein the indication of the priority associated with the UE is included in the data scheduling request.
Aspect 6: The method of any of Aspects 1-5, wherein the indication of the priority associated with the UE is transmitted via a D2 interface between the first DU and the second DU.
Aspect 7: The method of any of Aspects 1-6, further comprising: communicating, with the second DU, a range of priority values during a setup procedure for establishing a connection via an interface between the first DU and the second DU, wherein the priority associated with the UE is within the range of priority values.
Aspect 8: The method of any of Aspects 1-7, wherein transmitting the indication of the priority associated with the UE comprises: transmitting the indication of the priority associated with the UE to the second DU in a UE addition request or UE modification request associated with the UE.
Aspect 9: The method of any of Aspects 1-8, further comprising: transmitting, to the second DU in a UE addition request or UE modification request associated with the UE, an indication of a range of priority values associated with the UE, wherein the indication of the priority of the UE is included within the data scheduling request and indicates a priority value within the range of priority values associated with the UE.
Aspect 10: The method of any of Aspects 1-9, wherein transmitting the indication of the priority associated with the UE comprises: transmitting, to the second DU in a UE addition request or UE modification request associated with the UE, an indication of a first priority value associated with the UE; and transmitting, to the second DU in the data scheduling request, an indication of a second priority value associated with the UE, wherein the first priority value is a default priority value associated with the UE, and wherein the second priority value overrides the default priority value for the data scheduling request.
Aspect 11: The method of any of Aspects 1-10, wherein transmitting the indication of the priority associated with the UE comprises: transmitting, to the second DU, indications of per-UE priority values for a plurality of UEs including the UE.
Aspect 12: The method of any of Aspects 1-11, further comprising: determining the priority associated with the UE based on at least one of a UE identifier (ID) associated with the UE, a slice ID associated with the UE, or a quality of service (QoS) indicator for a data radio bearer (DRB) associated with the UE.
Aspect 13: The method of any of Aspects 1-12, further comprising: transmitting, to the second DU, a UE addition request or UE modification request associated with the UE, wherein the UE addition request or UE modification request indicates a first type of inter-DU carrier aggregation associated with primary cell (PCell) DU driven scheduling or a second type of inter-DU carrier aggregation associated with SCell DU driven scheduling.
Aspect 14: The method of Aspect 13, wherein transmitting the priority associated with the UE is based at least in part on the UE addition request or UE modification request indicating the first type of inter-DU carrier aggregation.
Aspect 15: The method of any of Aspects 13-14, wherein the UE addition request or UE modification request indicates the second type of inter-DU carrier aggregation by including data radio bearers (DRB) information, or wherein the UE addition request or UE modification request indicates the first type of inter-DU carrier aggregation by not including the DRB information.
Aspect 16: A method for wireless communication performed by a first distributed unit (DU), comprising: receiving, from a second DU, a data scheduling request for scheduling transmission of data from the first DU to a user equipment (UE) via a secondary cell (SCell) for the UE, and an indication of a priority associated with the UE; scheduling a data transmission to the UE via the SCell in accordance with the data scheduling request and the priority associated with the UE; transmitting, to the second DU, a data request associated with the data transmission to the UE via the SCell; and receiving, from the second DU, a data response including a transport block for the data transmission to the UE via the SCell.
Aspect 17: The method of Aspect 16, further comprising: transmitting, to the UE via the SCell, the data transmission including the transport block.
Aspect 18: The method of any of Aspects 16-17, wherein the second DU is associated with a primary cell (PCell) for the UE, and wherein the first DU is associated with the SCell for the UE.
Aspect 19: The method of any of Aspects 16-18, wherein the indication of the priority associated with the UE indicates a priority value associated with the UE.
Aspect 20: The method of any of Aspects 16-19, wherein the indication of the priority associated with the UE indicates a range of priority values associated with the UE.
Aspect 21: The method of any of Aspects 16-20, wherein the indication of the priority associated with the UE is included in the data scheduling request.
Aspect 22: The method of any of Aspects 16-21, wherein the indication of the priority associated with the UE is received via a D2 interface between the first DU and the second DU.
Aspect 23: The method of any of Aspects 16-22, further comprising: communicating, with the second DU, a range of priority values during a setup procedure for establishing a connection via an interface between the first DU and the second DU, wherein the priority associated with the UE is within the range of priority values.
Aspect 24: The method of any of Aspects 16-23, wherein receiving the indication of the priority associated with the UE comprises: receiving the indication of the priority associated with the UE from the second DU in a UE addition request or UE modification request associated with the UE.
Aspect 25: The method of any of Aspects 16-24, further comprising: receiving, from the second DU in a UE addition request or UE modification request associated with the UE, an indication of a range of priority values associated with the UE, wherein the indication of the priority of the UE is included within the data scheduling request and indicates a priority value within the range of priority values associated with the UE.
Aspect 26: The method of any of Aspects 16-25, wherein receiving the indication of the priority associated with the UE comprises: receiving, from the second DU in a UE addition request or UE modification request associated with the UE, an indication of a first priority value associated with the UE; and receiving, from the second DU in the data scheduling request, an indication of a second priority value associated with the UE, wherein the first priority value is a default priority value associated with the UE, and wherein the second priority value overrides the default priority value for the data scheduling request.
Aspect 27: The method of any of Aspects 16-26, wherein receiving the indication of the priority associated with the UE comprises: receiving, from the second DU, indications of per-UE priority values for a plurality of UEs including the UE.
Aspect 28: The method of any of Aspects 16-27, further comprising: receiving, from the second DU, a UE addition request or UE modification request associated with the UE, wherein the UE addition request or UE modification request indicates a first type of inter-DU carrier aggregation associated with primary cell (PCell) DU driven scheduling or a second type of inter-DU carrier aggregation associated with SCell DU driven scheduling.
Aspect 29: The method of Aspect 28, wherein receiving the priority associated with the UE is based at least in part on the UE addition request or UE modification request indicating the first type of inter-DU carrier aggregation.
Aspect 30: The method of any of Aspects 28-29, wherein the UE addition request or UE modification request indicates the second type of inter-DU carrier aggregation by including data radio bearers (DRB) information, or wherein the UE addition request or UE modification request indicates the first type of inter-DU carrier aggregation by not including the DRB information.
Aspect 31: A method of wireless communication performed by a first distributed unit (DU), comprising: receiving, from a second DU, a medium access control (MAC) control element (MAC-CE) transfer request including a MAC-CE payload associated with a secondary cell (SCell) for a user equipment (UE); appending the MAC-CE payload to a data buffer associated with the UE; and coordinating scheduling and transmission of the MAC-CE payload to the UE based on the data buffer associated with the UE.
Aspect 32: The method of Aspect 31, wherein the first DU is associated with a primary cell (PCell) for the UE, and wherein the second DU is associated with the SCell for the UE.
Aspect 33: The method of any of Aspects 31-32, further comprising: transmitting, to the second DU, a MAC-CE transfer request acknowledgement in connection with receiving the MAC-CE transfer request.
Aspect 34: The method of any of Aspects 31-33, further comprising: receiving, from the UE, an acknowledgment associated with the MAC-CE payload; and transmitting, to the second DU, a MAC-CE transfer complete message in connection with receiving the acknowledgement.
Aspect 35: The method of any of Aspects 31-34, wherein the MAC-CE transfer request is included in a downlink data request.
Aspect 36: The method of any of Aspects 31-35, wherein the MAC-CE payload is generated by the second DU.
Aspect 37: The method of any of Aspects 31-36, wherein the MAC-CE transfer request is received via a D2 interface between the first DU and the second DU.
Aspect 38: The method of any of Aspects 31-37, wherein coordinating the scheduling and the transmission of the MAC-CE payload to the UE comprises: scheduling a transmission of downlink data including the MAC-CE payload via a primary cell (PCell) for the UE; and transmitting, to the UE, the downlink data including the MAC-CE payload via the PCell.
Aspect 39: The method of any of Aspects 31-37, wherein coordinating the scheduling and the transmission of the MAC-CE payload to the UE comprises: transmitting, to the second DU, a downlink data scheduling request for scheduling transmission of downlink data to the UE via the SCell; receiving, from the second DU, a downlink data request associated with a scheduled downlink data transmission to the UE via the SCell; and transmitting, to the second DU, a transport block for the scheduled downlink data transmission to the UE via the SCell, wherein the transport block includes the MAC-CE payload.
Aspect 40: The method of Aspect 39, further comprising: transmitting, to the second DU, an indication of priority, associated with the UE, for scheduling transmission of downlink data to the UE via the SCell.
Aspect 41: A method of wireless communication performed by a first distributed unit (DU), comprising: generating a medium access control (MAC) control element (MAC-CE) associated with a secondary cell (SCell) for a user equipment (UE); and transmitting, to a second DU, a MAC-CE transfer request including a payload of the MAC-CE.
Aspect 42: The method of Aspect 41, wherein the second DU is associated with a primary cell (PCell) for the UE, and wherein the first DU is associated with the SCell for the UE.
Aspect 43: The method of any of Aspects 41-42, further comprising: receiving, from the second DU, a MAC-CE transfer request acknowledgement associated with the MAC-CE transfer request.
Aspect 44: The method of any of Aspects 41-43, further comprising: receiving, from the second DU, a MAC-CE transfer complete message associated with an acknowledgement of reception of the payload of the MAC-CE by the UE.
Aspect 45: The method of any of Aspects 41-44, wherein the MAC-CE transfer request is included in a downlink data request.
Aspect 46: The method of any of Aspects 41-45, wherein the MAC-CE transfer request is transmitted via a D2 interface between the first DU and the second DU.
Aspect 47: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-46.
Aspect 48: An apparatus for wireless communication at a device, the apparatus comprising one or more memories and one or more processors coupled to the one or more memories, the one or more processors configured to cause the device to perform the method of one or more of Aspects 1-46.
Aspect 49: An apparatus for wireless communication, the apparatus comprising at least one means for performing the method of one or more of Aspects 1-46.
Aspect 50: A non-transitory computer-readable medium storing code for wireless communication, the code comprising instructions executable by one or more processors to perform the method of one or more of Aspects 1-46.
Aspect 51: A non-transitory computer-readable medium storing a set of instructions for wireless communication, the set of instructions comprising one or more instructions that, when executed by one or more processors of a device, cause the device to perform the method of one or more of Aspects 1-46.
Aspect 52: A device for wireless communication, the device comprising a processing system that includes one or more processors and one or more memories coupled with the one or more processors, the processing system configured to cause the device to perform the method of one or more of Aspects 1-46.
Aspect 53: An apparatus for wireless communication at a device, the apparatus comprising one or more memories and one or more processors coupled to the one or more memories, the one or more processors individually or collectively configured to cause the device to perform the method of one or more of Aspects 1-46.
Aspect 54: A device comprising a processing system that includes one or more processors and one or more code-storing memories coupled with the one or more processors, the processing system configured to cause the device to perform the method of one or more of Aspects 1-46.
Aspect 55: A device comprising a processing system that includes processor circuitry and code-storing memory circuitry, the processing system configured to cause the device to perform the method of one or more of Aspects 1-46.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A first distributed unit (DU), comprising:
a processing system that includes one or more processors and one or more code-storing memories coupled with the one or more processors, the processing system configured to cause the first DU to:
transmit, to a second DU, a data scheduling request for scheduling transmission of data from the second DU to a user equipment (UE) via a secondary cell (SCell) for the UE, and an indication of a priority associated with the UE;
receive, from the second DU, a data request associated with a data transmission from the second DU to the UE via the SCell scheduled in accordance with the data scheduling request and the priority associated with the UE; and
transmit, to the second DU, a data response including a transport block for the data transmission from the second DU to the UE via the SCell.

2. The first DU of claim 1, wherein the first DU is associated with a primary cell (PCell) for the UE, and wherein the second DU is associated with the SCell for the UE.

3. The first DU of claim 1, wherein the indication of the priority associated with the UE indicates a priority value associated with the UE.

4. The first DU of claim 1, wherein the indication of the priority associated with the UE indicates a range of priority values associated with the UE.

5. The first DU of claim 1, wherein the indication of the priority associated with the UE is included in the data scheduling request.

6. The first DU of claim 1, wherein the indication of the priority associated with the UE is transmitted via a D2 interface between the first DU and the second DU.

7. The first DU of claim 1, the processing system is configured to cause the first DU to:
communicate, with the second DU, a range of priority values during a setup procedure for establishing a connection via an interface between the first DU and the second DU, wherein the priority associated with the UE is within the range of priority values.

8. The first DU of claim 1, wherein the processing system, to cause the first DU to transmit the indication of the priority associated with the UE, is configured to cause the first DU to:
transmit the indication of the priority associated with the UE to the second DU in a UE addition request or UE modification request associated with the UE.

9. The first DU of claim 1, wherein the processing system is configured to cause the first DU to:
transmit, to the second DU in a UE addition request or UE modification request associated with the UE, an indication of a range of priority values associated with the UE, wherein the indication of the priority of the UE is included within the data scheduling request and indicates a priority value within the range of priority values associated with the UE.

10. The first DU of claim 1, wherein the processing system, to cause the first DU to transmit the indication of the priority associated with the UE, is configured to cause the first DU to:
transmit, to the second DU in a UE addition request or UE modification request associated with the UE, an indication of a first priority value associated with the UE; and
transmit, to the second DU in the data scheduling request, an indication of a second priority value associated with the UE, wherein the first priority value is a default priority value associated with the UE, and wherein the second priority value overrides the default priority value for the data scheduling request.

11. The first DU of claim 1, wherein the processing system, to cause the first DU to transmit the indication of the priority associated with the UE, is configured to cause the first DU to:
transmit, to the second DU, indications of per-UE priority values for a plurality of UEs including the UE.

12. The first DU of claim 1, wherein the processing system is configured to cause the first DU to:
determine the priority associated with the UE based on at least one of a UE identifier (ID) associated with the UE, a slice ID associated with the UE, or a quality of service (QoS) indicator for a data radio bearer (DRB) associated with the UE.

13. The first DU of claim 1, wherein the processing system is configured to cause the first DU to:
transmit, to the second DU, a UE addition request or UE modification request associated with the UE, wherein the UE addition request or UE modification request indicates a first type of inter-DU carrier aggregation associated with primary cell (PCell) DU driven scheduling or a second type of inter-DU carrier aggregation associated with SCell DU driven scheduling.

14. The first DU of claim 13, wherein the processing system is configured to cause the first DU to transmit the priority associated with the UE based at least in part on the UE addition request or UE modification request indicating the first type of inter-DU carrier aggregation.

15. The first DU of claim 13, wherein the UE addition request or UE modification request indicates the second type of inter-DU carrier aggregation by including data radio bearers (DRB) information, or wherein the UE addition request or UE modification request indicates the first type of inter-DU carrier aggregation by not including the DRB information.

16. A first distributed unit (DU), comprising:
a processing system that includes one or more processors and one or more code-storing memories coupled with the one or more processors, the processing system configured to cause the first DU to:
receive, from a second DU, a data scheduling request for scheduling transmission of data from the first DU to a user equipment (UE) via a secondary cell (SCell) for the UE, and an indication of a priority associated with the UE;
schedule a data transmission to the UE via the SCell in accordance with the data scheduling request and the priority associated with the UE;
transmit, to the second DU, a data request associated with the data transmission to the UE via the SCell; and
receive, from the second DU, a data response including a transport block for the data transmission to the UE via the SCell.

17. The first DU of claim 16, wherein the indication of the priority associated with the UE is included in the data scheduling request.

18. The first DU of claim 16, wherein the processing system is configured to cause the first DU to:
communicate, with the second DU, a range of priority values during a setup procedure for establishing a connection via an interface between the first DU and the second DU, wherein the priority associated with the UE is within the range of priority values.

19. The first DU of claim 16, wherein the processing system, to cause the first DU to receive the indication of the priority associated with the UE, is configured to cause the first DU to:
receive the indication of the priority associated with the UE from the second DU in a UE addition request or UE modification request associated with the UE.

20. A first distributed unit (DU), comprising:
a processing system that includes one or more processors and one or more code-storing memories coupled with the one or more processors, the processing system configured to cause the first DU to:
receive, from a second DU, a medium access control (MAC) control element (MAC-CE) transfer request including a MAC-CE payload associated with a secondary cell (SCell) for a user equipment (UE);
append the MAC-CE payload to a data buffer associated with the UE; and
coordinate scheduling and transmission of the MAC-CE payload to the UE based on the data buffer associated with the UE.
